(19) United States
(12) Patent Application Publication
(10) Pub. No.: US 2026/0091989 A1
(43) Pub. Date: Apr. 2, 2026

(54) SYSTEM AND METHOD FOR PROVIDING POWER FOR DESALINATION USING ENERGY FROM WATER MOVEMENT

(71) Applicant: Hunt Innovative Technologies, L.L.C., Dallas, TX (US)

(72) Inventors: Todd W. Benson, Dallas, TX (US); James D. Franks, Louisville, KY (US); Angus Jamieson, Inverness (GB)

(21) Appl. No.: 19/346,232

(22) Filed: Sep. 30, 2025

Related U.S. Application Data
(60) Provisional application No. 63/702,246, filed on Oct. 2, 2024.

(51) Int. Cl. C02F 1/04; C02F 103/08

(52) U.S. Cl. CPC C02F 1/043; C02F 2103/08; C02F 2201/009; C02F 2301/063

(57) ABSTRACT

Described herein are systems and methods for harvesting energy from water movement to mechanically power desalination devices and other systems, such as irrigation systems. For example, a distillation system based on mechanical energy may include an energy harvesting system configured to obtain mechanical energy from water movement, an energy transfer mechanism coupled to the energy harvesting system to transfer the obtained mechanical energy to a distillation apparatus, and the distillation apparatus having a vacuum chamber and a vacuum mechanism driven only by the mechanical energy provided by the energy transfer mechanism to create a vacuum in the vacuum chamber in order to lower an amount of energy needed for distillation of the fluid to occur. The distilled water may then be used for irrigation, consumption, and other needs.

### CLAIM OF PRIORITY

This application claims priority to U.S. Patent Application 63/702,246, filed on Oct. 2, 2024, and entitled “SYSTEM AND METHOD FOR PROVIDING POWER FOR DESALINATION USING ENERGY FROM WATER MOVEMENT”, which is hereby incorporated by reference in its entirety.

### TECHNICAL FIELD

This application is directed to the generation of power using water movement for purposes such as the desalination of salt water for use in irrigation, livestock watering, industry, human consumption, and/or other purposes.

### BACKGROUND

The manner in which power is generated from water movement for purposes such as distillation and/or desalination is currently limited in functionality and flexibility. Accordingly, what is needed are a system and method that address these issues.

### BRIEF DESCRIPTION OF THE DRAWINGS

For a more complete understanding, reference is now made to the following description taken in conjunction with the accompanying Drawings in which:

FIGS. 1A-1C illustrate embodiments of an environment within which aspects of the present disclosure may be practiced, including an energy harvesting system and an energy storage/use system;

FIG. 2 illustrates another embodiment of the environment of FIGS. 1A-1C with a more detailed example of the energy storage/use system;

FIG. 3 illustrates another embodiment of the environment of FIGS. 1A-1C where the energy storage/use system includes a desalination and freshwater pumping station;

FIGS. 4A and 4B illustrate one embodiment of a device that may be used as the energy harvesting system of FIGS. 1A-1C;

FIGS. 4C and 4D illustrate another embodiment of the device of FIGS. 4A and 4B;

FIG. 5 illustrates one embodiment of a portion of the device of FIGS. 4A and 4B;

FIG. 6 illustrates an alternate embodiment of the device of FIGS. 4A and 4B;

FIG. 7 illustrates another embodiment of a device that may be used as the energy harvesting system of FIGS. 1A-1C;

FIGS. 8A and 8B illustrate a paddle component of the device of FIG. 7 in an engaged position (FIG. 8A) and a disengaged position (FIG. 8B);

FIG. 9 illustrates the device of FIG. 7 deployed with a different water current pattern;

FIG. 10 illustrates one embodiment of a device that may be used as the energy harvesting system of FIGS. 1A-1C;

FIGS. 11A and 11B illustrate another embodiment of a device that may be used as the energy harvesting system of FIGS. 1A-1C;

FIGS. 11C and 11D illustrate another embodiment of a device that may be used as the energy harvesting system of FIGS. 1A-1C;

FIGS. 11E-11G illustrate alternate embodiments of the device of FIGS. 11C and 11D;

FIG. 11H illustrates another embodiment of a device that may be used as the energy harvesting system of FIGS. 1A-1C;

FIGS. 12A-12D illustrate another embodiment of a device that may be used as the energy harvesting system of FIGS. 1A-1C;

FIGS. 13A-13E illustrate another embodiment of a device that may be used as the energy harvesting system of FIGS. 1A-1C;

FIG. 14 illustrates one embodiment of a device that may be used as the energy harvesting system of FIGS. 1A-1C;

FIGS. 15A-15C illustrate one embodiment of a device that may be used as the energy harvesting system of FIGS. 1A-1C;

FIGS. 16A and 16B illustrate one embodiment of a device that may be used as the energy harvesting system of FIGS. 1A-1C;

FIG. 17 illustrates one embodiment of a system that may be used as the energy harvesting system of FIGS. 1A-1C;

FIG. 18A illustrates one embodiment of a desalination system;

FIGS. 18B-18F illustrate another embodiment of a desalination system;

FIGS. 19A-19I illustrate one embodiment of a drive mechanism that may be used in the desalination system of FIGS. 18B-18F;

FIG. 20 illustrates one embodiment of a control system that may be part of, or used with, an energy harvesting system and/or an energy storage/use system;

FIG. 21 is a flow chart illustrating one embodiment of a process that may be executed by the control system of FIG. 20; and

FIG. 22 is a simplified diagram of one embodiment of a computer system that may be used in embodiments of the present disclosure.

### DETAILED DESCRIPTION

Referring now to the drawings, wherein like reference numbers are used herein to designate like elements throughout, the various views and embodiments of a system and method are illustrated and described, and other possible embodiments are described. The figures are not necessarily drawn to scale, and in some instances, the drawings have been exaggerated and/or simplified in places for illustrative purposes only. Features which are described in the context of separate aspects and embodiments of the invention may be used together and/or be interchangeable. Similarly, features described in the context of a single embodiment may also be provided separately or in any suitable subcombination. One of ordinary skill in the art will appreciate the many possible applications and variations based on the following examples of possible embodiments.

Significant amounts of land are positioned adjacent to, or relatively near, large bodies of saltwater such as oceans and seas. Except for a lack of fresh water, such land may be used to raise crops and/or animals, to provide for housing and/or industrial needs, and/or for other purposes. The lack of fresh water may be the result of such natural occurrences as relatively arid conditions, geographic features, and/or other obstacles. Saltwater may even contaminate fresh groundwater in coastal areas, further reducing the availability of fresh water.

Supplying adequate fresh water to such relatively arid lands from other areas may not be realistic due to the costs involved in constructing and maintaining the infrastructure needed to move water across difficult terrain (e.g., mountainous areas) and/or over long distances. This may be particularly true if the areas to be irrigated are relatively small compared to the costs involved. For example, smaller (e.g., one hundred acre plots) scattered along a coastline may be beneficial to those living nearby if irrigated, but may not be considered significant enough for the investment required for a major infrastructure project. This lack of infrastructure may result in the inability to provide enough water for raising crops and/or animals, the inability to provide enough water for population centers, and/or other issues.

Furthermore, in areas where the desalination of saltwater is possible, significant amounts of energy may be needed to remove the salt and/or other minerals from a volume of water needed to be useful, and building and maintaining the infrastructure to provide power to such areas may not be cost effective. Furthermore, building power sources in and/or near a coastal body of water should take into account potential interference with the marine environment, including marine life, vehicles (e.g., boats, watercraft such as jet skis, and ships), and/or personal entertainment and/or tourism uses (e.g., swimming and surfing at public beaches).

The present disclosure describes systems and methods by which salt water may be desalinated using water movement as a power source. The systems may be implemented above and/or under the water in ways that minimize the disruption of the marine environment, such as marine life, water vehicles, and/or other water uses. By providing a power source that uses the energy provided by water movement, infrastructure may be provided even in relatively remote areas, thereby enabling such areas to be used for raising crops and/or animals, industry, supporting people attending to such crops, animals, and/or industry, and/or to support population centers.

In addition to the difficulty of fresh water provision, supplying power to such areas or maintaining generators to create local electrical power may not be realistic due to the costs involved in constructing and maintaining the infrastructure needed to move power and/or fuel across difficult terrain (e.g., mountainous areas) and/or over long distances. This may be particularly true if the areas to be serviced are relatively small compared to the costs involved. For example, smaller communities scattered along a coastline may not be considered significant enough for the investment required for a major infrastructure project and/or for maintaining a sufficient fuel supply on a regular basis. This lack of electrical power may make the provision of artificial cooling, heating, and/or other operations (e.g., desalination) cost prohibitive or simply not possible.

Designing and deploying energy harvesting systems that rely on mechanical power in a scalable manner may enable the resources to service a relatively wide range of uses, from irrigating smaller plots of land to providing water for larger industrial and domestic uses. For example, in a coastal community that is difficult to supply with electricity in a conventional manner (e.g., due to topography and/or isolation making it difficult to run electrical lines), one or more energy harvesting systems described herein may be deployed that use wind, wave, and/or animal power mechanical energy. In some implementations, one or more power sources may be used to provide heat for desalination of water for cooking, drinking, sanitation, and/or other needs.

One or more other power sources may be used to provide refrigeration for consumables such as fish and/or milk to decrease spoilage that would otherwise result from the ambient temperature. In another implementation, a single power source may be used to provide both heat (e.g., for desalination and/or distilling) and cooling (e.g., for cooling food) simultaneously. The source of mechanical power for the energy harvesting systems described herein may include windmills, wave and current force harvesting mechanisms, animal powered mills (e.g., using a rotating wheel), treadmills and/or chain type pedal systems (e.g., stationary cycles using parasitic energy generation from the effort to pedal or being regenerative braking driven), and/or any other mechanical energy source.

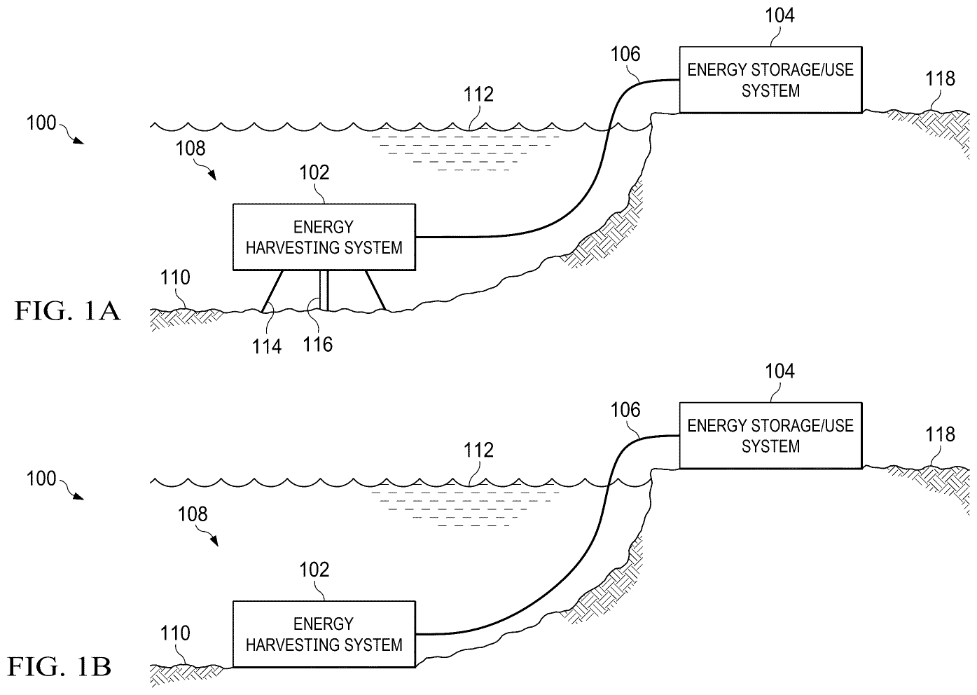

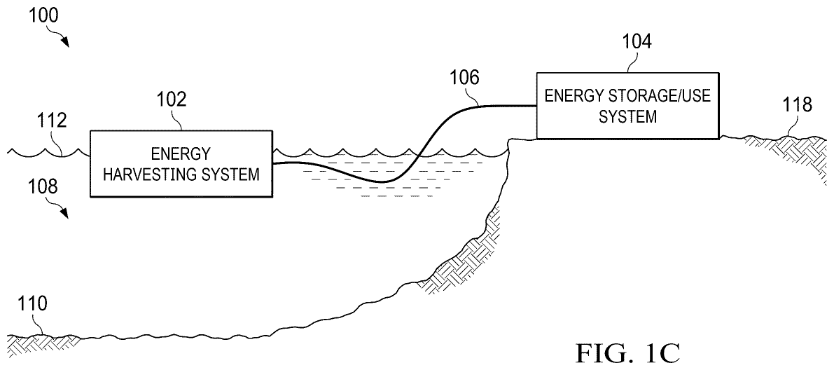

Referring to FIGS. 1A-1C, embodiments of an environment 100 are shown with different deployments of an energy harvesting system 102. The energy harvesting system 102 may be designed to capture kinetic energy from water movement that occurs at the water's surface and/or below the surface, and transfer that energy to an energy storage and/or use system 104. The energy may be transferred via one or more energy transfer mechanisms 106, which may represent electrical lines, fluid or hydraulic lines, mechanical mechanisms, and/or other energy transfer systems or combinations thereof. Such mechanisms 106 may be floating or submerged, and may be weighted in some embodiments.

Generally, it may be desirable for the energy harvesting system 102 to be positioned so there is relatively constant water movement around the system, as water movement is needed to produce energy. Coastal areas, rivers, and other bodies of water with regular water movement may be ideal marine environments for the energy harvesting system 102. Although water movement is needed to produce harvestable energy, too much water movement may be detrimental to the system's operation and/or longevity, and may impact the ability to perform maintenance. Additionally, designs of the energy harvesting system 102 and/or deployment locations may be selected, at least in part, on such factors as silt levels and/or other materials in the water that may affect the system's operation and/or longevity.

The energy storage/use system 104 may receive energy generated by the energy harvesting system 102 and convert (if needed, for example, from mechanical energy to electrical energy if such conversion is not performed by the energy harvesting system), store, directly use, and/or transfer the energy to other systems for storage, use, and/or further distribution. In some embodiments, motion from the energy harvesting system 102 may be used directly, such as using a stroking or pumping motion from a line to generate a pumping action. Such motion-based direct actions may be used for stamping sheet metal, grinding sugar cane, cutting wood, and/or performing other tasks that can be accomplished using such stroking and pumping motions.

It is understood that the conversion, storage, use, and/or distribution of such energy may be accomplished at a single location or at multiple locations, and may depend on such factors as current demand for energy at one or more locations and/or geographic areas, available storage, and/or other factors. In some embodiments, some or all components of the energy storage/use system 104 may be combined with the energy harvesting system 102.

In FIGS. 1A-1C, the energy harvesting system 102 is illustrated in a body of water 108, which may be a sea, ocean, river, delta, channel, and/or other bodies of water with enough water movement to provide harvestable energy. In the example of FIG. 1A, the energy harvesting system 102 may be vertically positioned between a submerged bed 110 (e.g., a seabed or riverbed) and the water's surface 112, and may be at varying distances from the shore. In FIG. 1B, the energy harvesting system 102 is positioned on the bed 110. In FIG. 1C, the energy harvesting system 102 is positioned at the surface 112, although it is understood that a portion of the system may be submerged.

The distance from the shore, bed 110, and/or the water's surface 112 may depend on many different factors, such as the slope of the bed, the depth of the water, the speed of currents and/or tidal changes, high and low tide positions, and/or other factors. Securing mechanisms may be used to secure the energy harvesting system 102 in place, and may include lines 114 and/or posts 116. The lines 114 may be secured to the bed 110 via anchors such as weights and/or posts that are driven into the bed.

Other components, such as floats, weights, ballast tanks, and/or fins may be used to maintain a position and/or orientation of the energy harvesting system 102. Such components may be part of the energy harvesting system 102 or may be coupled to the system as desired. Some or all of the components may be passive or may be controllable. For example, fins may be used to maintain the system's depth and/or orientation with respect to water flow, and such fins may be static or may be controlled (e.g., via a controller such as a computer processor).

In another example, the lines 114 and/or posts 116, as well as other components (e.g., ballast tanks), may be controllable to lower the energy harvesting system 102 towards the bed 110 in stormy weather and/or to minimize damage due to other events. For example, if nearby boat activity is detected, the energy harvesting system 102 may be manually or automatically lowered to minimize the risk of impact with the boat's hull and/or propeller(s).

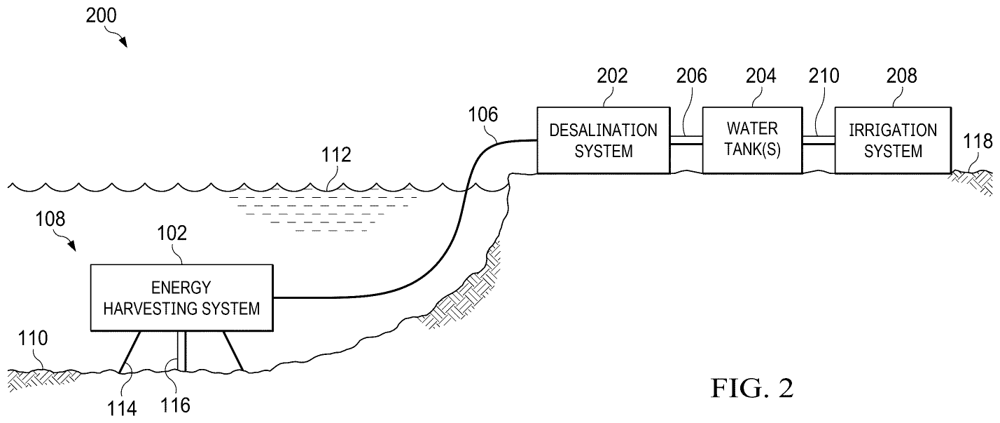

Referring to FIG. 2, an environment 200 illustrates a more detailed embodiment of the energy storage/use system 104 of FIGS. 1A-1C. The energy storage/use system 104 may include a desalination system 202, one or more water tanks 204, and/or an irrigation system 208. In some embodiments, the water tank(s) 204 and/or the irrigation system 208 may not be part of the energy storage/use system 104. In the present example, the mechanism 106 is coupled to the desalination system 202. One or more pipes 206 may couple the desalination system 202 to the water tank(s) 104. The irrigation system 208 may be coupled to the water tank(s) 204 via one or more pipes 210. The water tank(s) 204 may not be present in some embodiments, or may be part of the desalination system 202 and/or the irrigation system 208. In some examples, peak wave/river action may be used to directly pump water for external uses, and water from the tank(s) 204 may be used to smooth out water distribution when there is less wave/river action.

The desalination system 202 may use one or more processes, including distillation (e.g., multi-stage flash distillation (MSF), multiple-effect distillation (MED), and vapor-compression (VC)), ion exchange, membrane processes (e.g., electrodialysis reversal (EDR), reverse osmosis (RO), nanofiltration (NF), membrane distillation (MD), and forward osmosis (FO)), freezing desalination, geothermal desalination, solar desalination (e.g., solar humidification-dehumidification (HDH), multiple-effect humidification (MEH), and seawater greenhouse), methane hydrate crystallization, solar natural vacuum desalination (SNVD), high grade water recycling, and/or wave-powered desalination. A remineralization filter may be included in the desalination system to treat water before use in drinking, agriculture, and/or other applications. It is understood that the desalination system 202 may operate in many different ways, and energy provided by the energy storage/use system 104 may be transferred entirely to the desalination system, or may be used for other purposes as well.

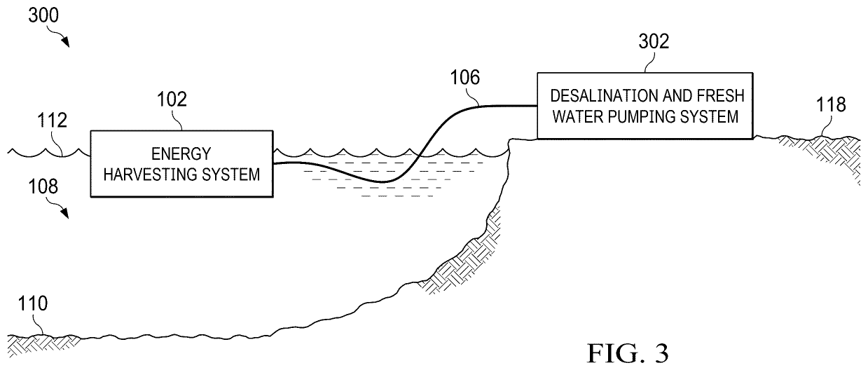

Referring to FIG. 3, an environment 300 illustrates an embodiment where the energy storage/use system 104 of FIGS. 1A-1C is a desalination and freshwater pumping station 302. For example, the desalination and freshwater pumping station 302 may be a relatively small unit that can be used to irrigate smaller areas (e.g., tens of acres to one or two hundred acres). Such relatively small units may be more affordable and more easily distributed without needing a larger infrastructure as may be needed by, for example, the environment of FIG. 2. Smaller units may be placed in areas that do not need, or are not able to support, a larger irrigation infrastructure, either due to lack of relatively large contiguous areas of arable land, the presence of geographic attributes that makes installing pipes over a larger area impractical, and/or for other reasons.

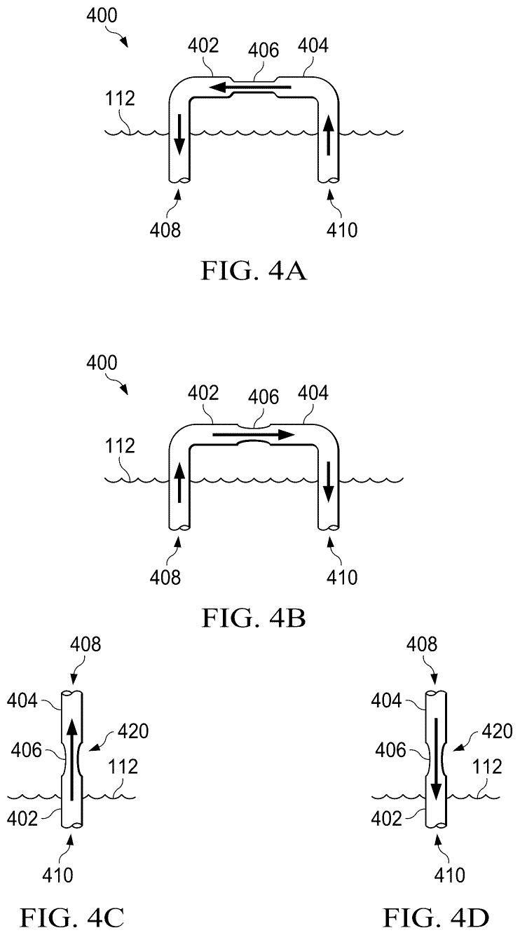

Referring to FIGS. 4A and 4B, a device 400 illustrates one embodiment of at least a portion of the energy harvesting system 102 of FIG. 1. In the present example the device 400 is an inverted U-shaped tube structure with the ends of tubes 402 and 404 submerged below the surface 112. The tubes 402 and 404 are joined by a section 406 that may be narrower in diameter than the tubes, with gas(es) (e.g., air) trapped in the section 406 and upper portions of the tubes 402 and 404.

With additional reference to FIGS. 4C and 4D, a device 420 illustrates another embodiment of the device of FIGS. 4A and 4B. In the present example, the device 420 is a single tube that is substantially vertically oriented relative to the water, but the device may be angled in some embodiments. In other embodiments, the tubes 402 and 404 of FIGS. 4A-4D may be coiled and/or have other shapes than those shown.

In FIGS. 4A-4D, water may ebb and flow within the tubes 402 and 404 via openings 408 and 410, respectively, which pushes the air back and forth through the section 406. One or more mechanisms may be coupled to, or located within, the device 400 to capture energy from the moving air. In other embodiments, the devices 400 and 420 may have a single tube or more than two tubes, or may be a combination of multiple tubes, including tubes that feed into one another. The section 406 may be narrow relative to the tubes 402 and 404 to increase the velocity of air passing through the section.

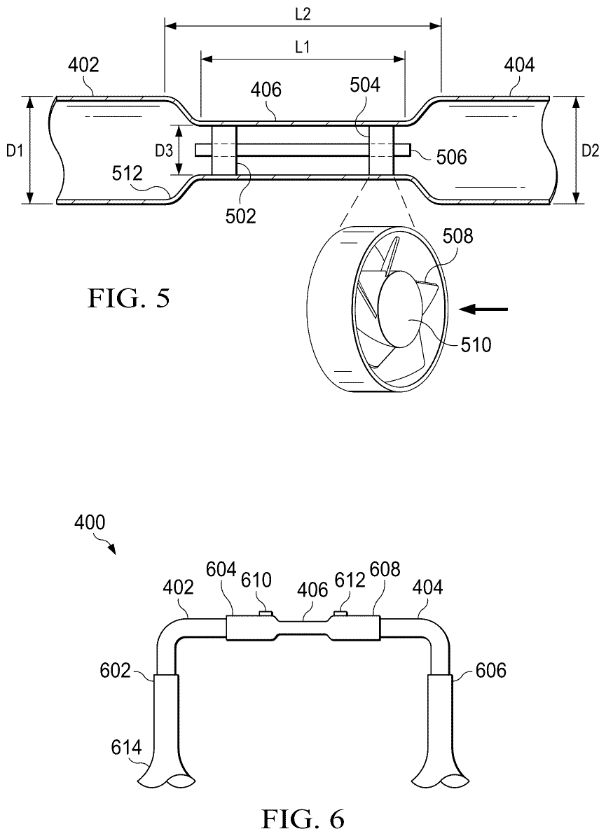

With additional reference to FIG. 5, one embodiment of the section 406 is illustrated with two impellers 502 and 504 coupled to a center shaft 506. The impellers 502 and 504 may include blades 508 that are coupled to a shaft or spindle 510, which may be the shaft 506 or may be coupled to the shaft 506. In the present example, the impellers 502 and 504 may include one way bearings that limit rotation of the shaft to a single direction. It is understood that a single impeller or more than two impellers may be used, and one or more impellers may be positioned differently than shown.

Continuing the present example, by mounting the impellers 502 and 504 with opposing orientations, airflow in one direction through the section 406 (e.g., flow from the end 410 to the end 408) may cause rotation of the shaft 506 in one direction (e.g., clockwise or counterclockwise). Airflow in the other direction through the section 406 (e.g., flow from the end 408 to the end 410) may cause rotation of the shaft 506 in the same clockwise or counterclockwise direction.

For example, airflow from the end 410 to the end 408 may turn the impeller 504 to rotate the shaft 506 clockwise (relative to the direction of flow), while airflow from the end 408 to the end 410 may turn the impeller 502 to rotate the shaft 506 counterclockwise (relative to the direction of airflow). This means the shaft 506 will be turning the same direction both times regardless of the airflow's direction through the section 406. In other embodiments, the shaft 506 may be rotated in opposite directions when the airflow through the device 400 switches directions. In still other embodiments, a series of one-way valves may be used to cause the airflow's orientation to provide rotational force in a single direction.

It is understood that various dimensions of the device 400 may be modified. For example, the interior diameter D1 of the tube 402, the interior diameter D2 of the tube 404, and/or the interior diameter D3 of the section 406 may be altered to achieve desired performance parameters. Similarly, the length L1 of the section 406, the length L2 of the section 406 and the slope 512 to the diameter D2, and the shape and/or rise/run of the slope itself may be altered. It is further understood that the device 400 may not be symmetrical in some embodiments, but may have various diameters, curves, tapered areas, chokes, inserts (e.g., filters and/or valves), and/or other features to achieve desired performance parameters, for manufacturing, assembly, and/or maintenance purposes, and/or for other reasons.

Referring to FIG. 6, another embodiment of the device 400 of FIG. 4A includes a configuration that may automatically and/or manually adjusted. For example, the tube 402 may include movement mechanisms (e.g., sleeves) 602 and/or 604 that enable their respective portions to shorten and lengthen. Similarly, the tube 404 may include movement mechanism 606 and/or 608. Shortening and lengthening may be controlled to adjust to various environmental changes, such as changes in the distance between wave troughs and crests, the desire to move greater and/or lessor amounts of air through the portion 406, and/or for other reasons.

In some embodiments, one or more valves 610 and 612 may be used to allow air to enter and/or exit the device 400 in order to adjust the air pressure within the device. For example, one or more one-way valves 610 may be used to allow air to pass into the device 400, while one or more other one-way valves 612 may be used to allow air to exit the device. Such valves may be selected to actuate at certain pressures in order to release or take in air only after the pressure differential needed to open the valve is reached.

In some embodiments one or both open ends of the tubes 402 and 404 may include a scooped or otherwise shaped opening 614 to facilitate water entry into the respective tube. It is understood that many different shapes may be used, and the tubes 402 and 404 may have matching or different shapes. The shaped openings 614 may be oriented the same or differently for each tube 402 and 404, and such orientation may depend on the orientation of the device 400 relative to the waves. For example, if the device 400 is positioned with the tubes 402 and 404 substantially equidistant from the shore, the scoops 614 may be in a particular direction with respect to their tubes. In another example, if the device 400 is positioned with the tube 402 positioned between the shore and the section 406, and the tube 404 positioned on the other side of the section 406 relative to the shore, the scoops may be oriented differently with respect to their tubes than in the previous example.

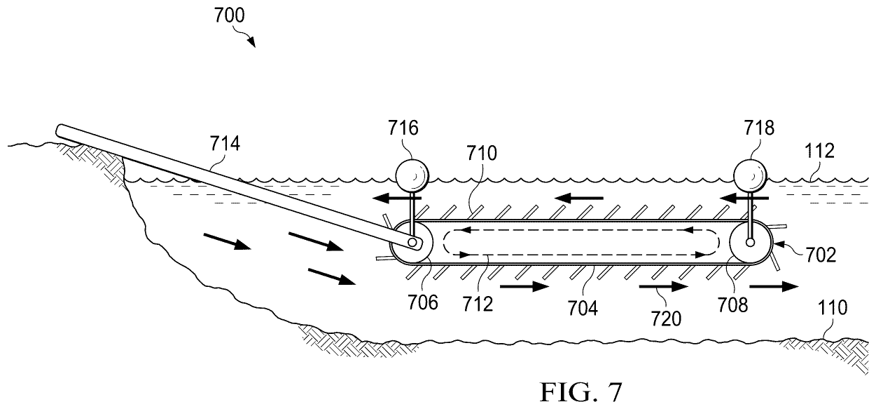

Referring to FIG. 7, an environment 700 illustrates another embodiment of a device 702 that represents at least a portion of the energy harvesting system 102 of FIG. 1. The device 702 includes a belt 704 that rotates around two or more pulleys 706 and 708. Paddles 710 may be coupled to the belt 704 to drive the belt in a direction indicated by arrow 712, which in turn rotates the pulleys 706 and 708.

In the present example, the pulley 706 may be coupled to a drivetrain (e.g., a telescoping drivetrain) that transfers the rotational energy of the pulley to the energy storage/use system 104 (FIG. 1A). It is understood that many different types of energy transfer mechanisms may be used in addition to, or as alternatives to, the drivetrain 714. Components 716 and 718 (e.g., floats, weights, ballast tanks, and/or fins) may be used to maintain a position and/or orientation of the device 700 relative to the shore, bed 110, and/or waves.

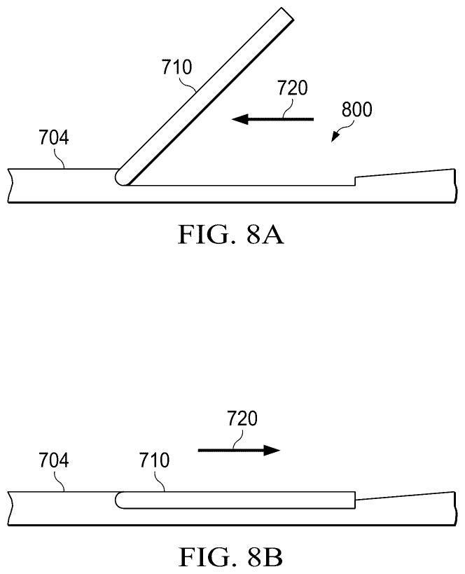

With additional reference to FIGS. 8A and 8B, the paddles 710 may be coupled to the belt 704 in a manner that enables the paddles to lie relatively flat (FIG. 8A) or to extend from the belt at an angle (FIG. 8B). For example, in FIG. 8A, the current's direction 720 is pushing the tip of the paddle 710 out of its resting indentation 800 and upwards away from the belt 704. The tip of the paddle 710 (e.g., by having a lip or other feature) and/or the shape of the indentation may be designed to aid the water in raising the paddle off the belt. In FIG. 8B, the current's direction 720 is pushing the tip of the paddle 710 towards the belt 704 and into the indentation 800. This may aid in moving the belt 704 in a single direction, as a current moving in a single direction across the device 400 may cause some of the paddles 710 to lie down while pushing the belt with the other paddles.

Referring again to FIG. 7, the current may move in different directions around the device 702. For example, the current near and around the top of the device 702 may be moving towards the shore, while the current near and around the bottom of the device may be flowing away from the shore. In this scenario, the device 702 may be oriented to capture the energy provided by both current directions because the paddles 710 are pushed upright by the different current directions as illustrated. In some embodiments, the distance between the upper and lower surfaces of the belt 704 may be modified as needed to place the paddles 710 in positions to better catch the energy of the water moving in the two different directions (e.g., inflow and outflow relative to the shore). Furthermore, one or both of the upper and lower surfaces may be angled to better harvest the water's energy. For example, the lower surface may be angled relative to the bed 110 if such an angle enables the harvesting of additional energy from water moving away from shore along the bed.

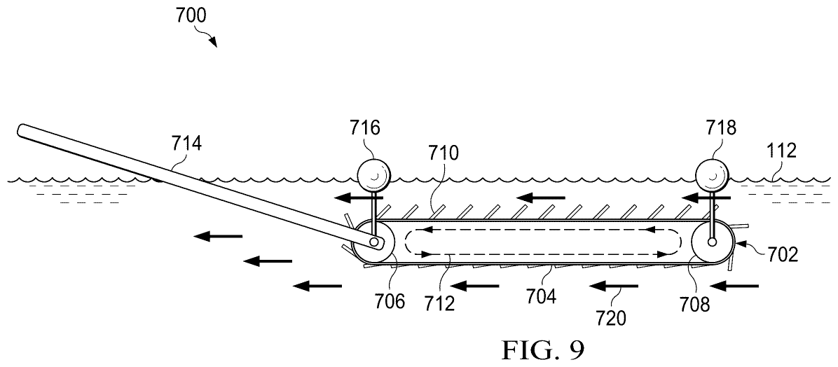

With additional reference to FIG. 9, the device 702 is illustrated as being deployed where the current around the device is moving in a single direction. In this scenario, the device 702 may be oriented to capture the energy using only the top paddles 710, because the paddles 710 at the bottom are pushed down towards the belt 704 as shown in FIG. 8B.

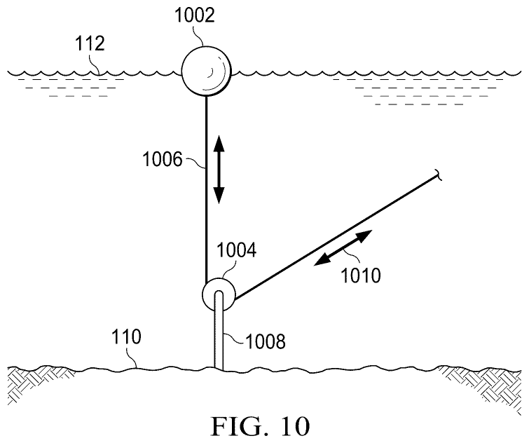

Referring to FIG. 10, an environment 1000 illustrates an embodiment of a system that represents at least a portion of the energy harvesting system 102 of FIG. 1. The system includes a float 1002 (e.g., a buoy) coupled to a pulley 1004 via one or more lines 1006. The pulley 1004 may be secured to the bed 110 using a post 1008 (e.g., the post 116 of FIG. 1A) and/or lines (not shown). The post 1008 may be driven into the bed 110 or may be coupled to an object having sufficient weight to prevent movement of the pulley 1004 relative to the bed. The line 1006 runs from the float 1002 to the pulley 1004, and from the pulley to the shore. For example, the line 1006 may be coupled to the energy storage/use system 104 of FIG. 1A. The float 1002 may be positioned at or near the surface, or may be submerged (e.g., to interact with underwater currents moving the float back and forth rather than primarily up and down as caused by interaction with surface waves).

In operation, as the float 1002 is moved vertically (and potentially somewhat horizontally) relative to the pulley 1004 due to the waves 112, the line 1006 may move back and forth as indicated by arrow 1010. This movement may result in a pumping or stroking force at the shore, which may be used directly and/or converted into other forms of energy. The amount of force generated may vary based on such factors as the length of the line 1006, the number of lines used, the number of pulleys used, the size of the float, the strength of the waves/currents, and/or other factors. As with all lines discussed herein, a tension device (not shown) may be used to manage slack in the line if needed.

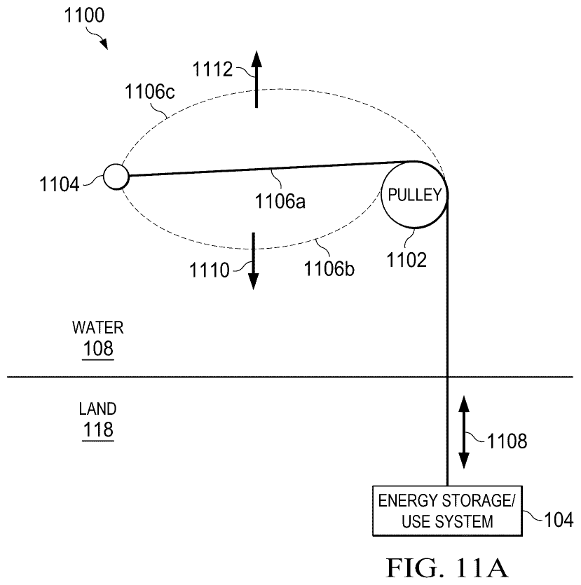

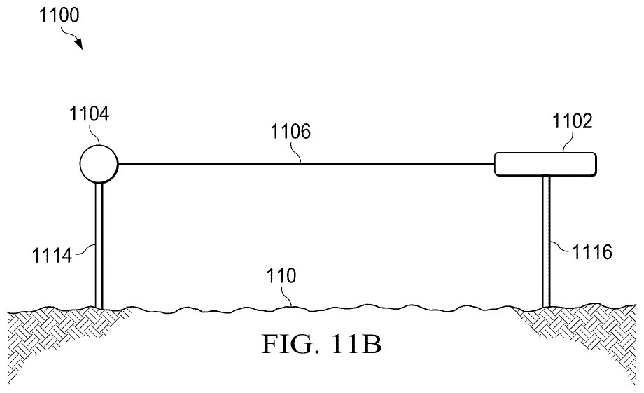

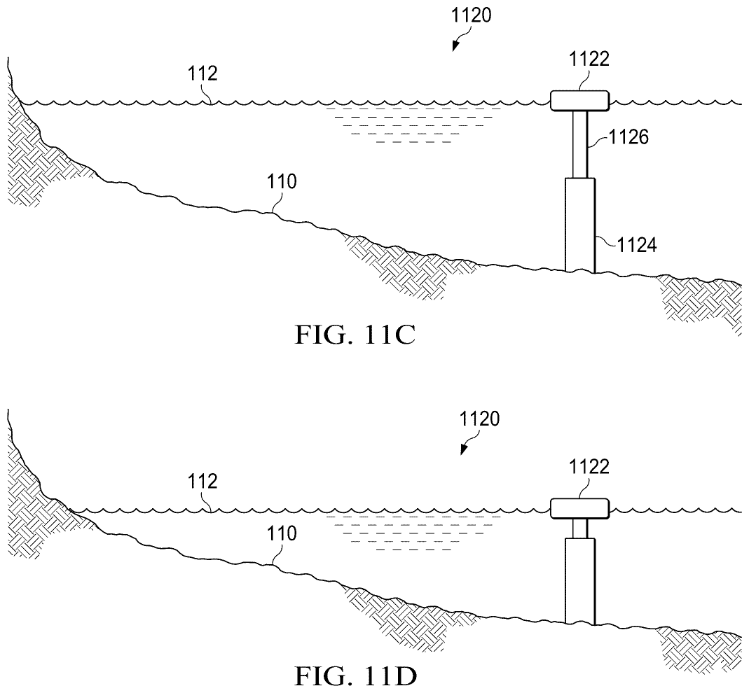

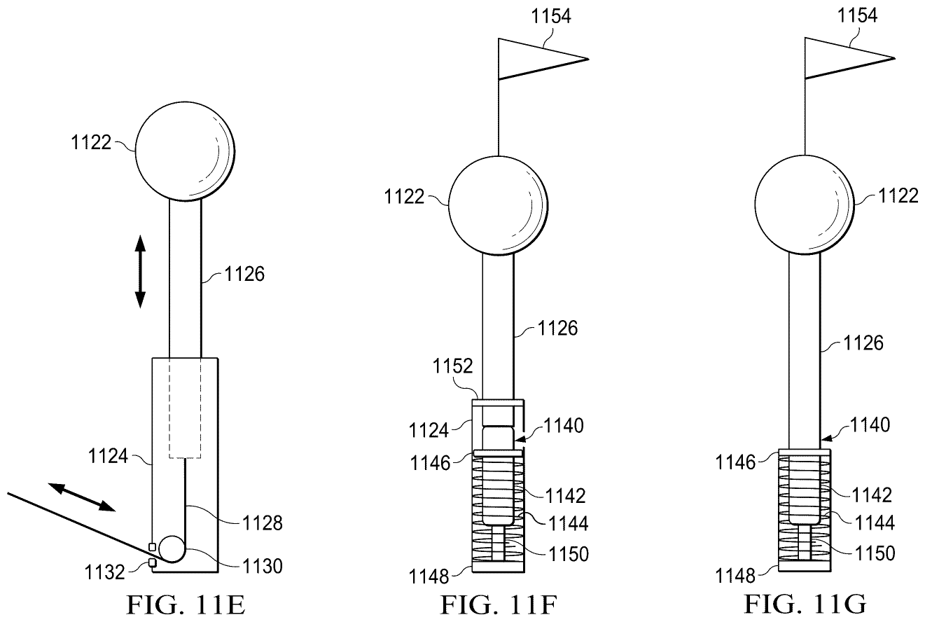

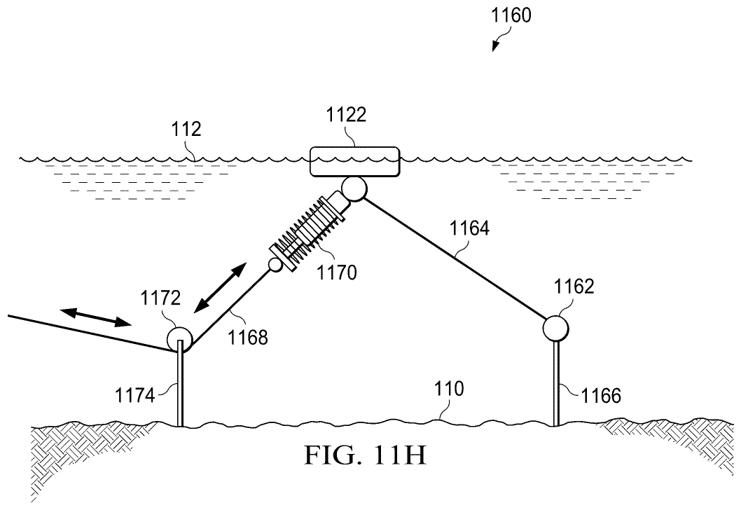

Referring to FIGS. 11A and 11B, an environment 1100 illustrates an embodiment of a system that represents at least a portion of the energy harvesting system 102 of FIG. 1. The system includes a pulley 1102 coupled to an anchor 1104 via one or more lines 1106. The pulley 1102 and anchor 1104 may be secured to the bed 110 using posts 1114 and 1116, respectively (e.g., the post 116 of FIG. 1A), and/or lines (not shown). The posts 1114 and 1116 may be driven into the bed 110 or may be coupled to objects having sufficient weight to prevent movement of the pulley 1102 and anchor 1104 relative to the bed. The line 1106 runs from the anchor 1104 to the pulley 1102, and from the pulley to the shore. For example, the line 1106 may be coupled to the energy storage/use system 104 of FIG. 1A. The line 1106 may be positioned at or near the surface, or may be submerged (e.g., to interact with underwater currents rather than surface waves).

In operation, the line 1106a may represent a neutral line position when no wave forces are acting on the line. Line 1106b may represent a line position that occurs when a wave force 1110 is pushing the line towards the shore (e.g., an incoming wave relative to the shore). Line 1106c may represent a line position that occurs when a wave force 1112 is pushing the line away from the shore (e.g., an outgoing wave relative to the shore). This back and forth movement results in a pumping or stroking force at the shore as indicated by arrow 1108, which may be used directly and/or converted into other forms of energy. The amount of force generated may vary based on such factors as the length of the line 1006, the number of lines used, the number of pulleys used, the strength of the waves/currents, and/or other factors.

The line 1106 may be configured with features (e.g., components such as floats and/or fins, and/or shapes such as pockets and/or other features), and such components and features may be attachments and/or built-in to the line. The components and features may increase the surface area of the line in order to create more drag and, accordingly, more pressure on the line from the waves. In some embodiments, marine vegetation (e.g., kelp) may be grown or allowed to grow on the line for similar reasons.

Referring to FIGS. 11C and 11D, an environment 1120 illustrates an embodiment of a system that represents at least a portion of the energy harvesting system 102 of FIG. 1. The system includes a float 1122 coupled to a submerged sleeve 1124 via an extension (e.g., a pole) 1126. The sleeve 1124 includes a cavity sized to receive some or all of the extension 1126. In some embodiments, the sleeve 1124 may be solid, may be formed by a wire frame, and/or may be formed in other ways. The opening of the cavity may include a seal (not shown) that abuts the extension 1126 to prevent sand, seaweed, and/or marine life from entering the cavity. The sleeve 1124 may be directly coupled to the bed 110 or may be coupled to one or more other devices (e.g., anchors) that are coupled to the bed.

In operation, when the tide is higher (FIG. 11C), the float 1122 rises with the water level and the extension 1126 extends further from the sleeve 1124. When the tide is lower (FIG. 11D), the float 1122 lowers with the water level and some or all of the extension 1126 retracts into the sleeve 1124. It is understood that the physical dimensions of the sleeve 1124 and/or extension 1126 may vary based on the depth at which the sleeve is positioned relative to the surface of the water, the force of tidal currents acting on the sleeve 1124 and extension 1126, and/or other factors.

With additional reference to FIG. 11E, one embodiment of an interior view of the sleeve 1124 is illustrated, showing a portion of the extension 1126 that is positioned within the sleeve. Force may be imparted to the shore from the vertical motion of the float 1122 by, for example, a cable 1128 coupled to the extension 1126. The other end of the cable 1128 may exit the sleeve 1124 via an opening in the sleeve. One or more pulleys 1130 may be positioned within the sleeve 1124 to redirect the cable's vertical force towards the shore. An abrasion prevention component (e.g., a grommet) 1132 may be positioned within a hole in the sleeve 1124 to reduce wear on the cable 1128.

Referring to FIGS. 11F and 11G, alternate embodiments of the float 1122 and sleeve 1124 of FIG. 11E are illustrated. In the present examples, a tension assembly 1140 may be positioned within the sleeve 1124, coupled to the bed 110 without a sleeve, and/or anchored to the bed in other ways. In the present example, the tension assembly 1140 is positioned within the sleeve 1124. A seal 1152 may be used to minimize the ingress of sand, seaweed, and/or marine life into the sleeve 1124. The tension assembly 1140 may be coupled to the extension 1126 (FIG. 11F) or may be coupled directly to the buoy 1122 (FIG. 11G) if the tension assembly has a component of sufficient length. A flag or other visibility device 1154 may be coupled to the buoy 1122 in some embodiments.

The tension assembly 1140 may include a dampening body 1142. A spring 1144 may be positioned around at least a portion of the dampening body 1142 and held in position by retaining components 1146 and 1148. The retaining components 1146 and 1148 may be coupled to the dampening body 1142. The dampening body 1142 may include a cavity along a centerline of the body and may slide along a center rod 1150 that is positioned within the cavity.

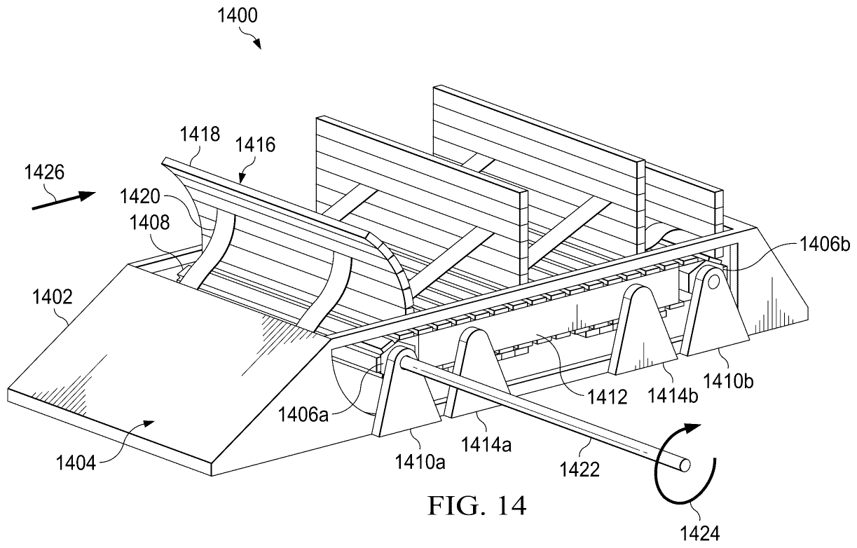

In operation, the spring 1144 may pull the float 1122 down, but not with enough force to submerge the float itself. Instead, the spring 1144 may provide sufficient force to keep the float 1122 securely on the surface. In addition, the spring 1144 may be used to generate additional tension for energy harvesting purposes. The dampening body 1142 may provide a relatively slow adjustment for water level differences due to tidal changes. Force may be imparted to the shore using a cable as shown with respect to FIG. 11E, using a drivetrain or rod (as shown with respect to FIGS. 7 and 14), and/or using any other suitable type of energy transfer mechanism.

Referring to FIG. 11H, an environment 1160 illustrates an embodiment of a system that represents at least a portion of the energy harvesting system 102 of FIG. 1. The system includes a float 1122 coupled to an anchor 1162 via a cable 1164. The anchor 1162 may be secured to the bed 110 using a post 1166 and may include a pivot that enables the cable 1164 to move relatively freely and prevent binding.

Another cable 1168 may be coupled to the float 1122 via a tension assembly 1170. The tension assembly 1170 may be similar to the tension assembly 1140 of FIGS. 11F and 11G. Force may be imparted to the shore using the cable 1172, which may be stabilized relative to the float 1122 using one or more pulleys 1172 secured to the bed 110 by a post 1174.

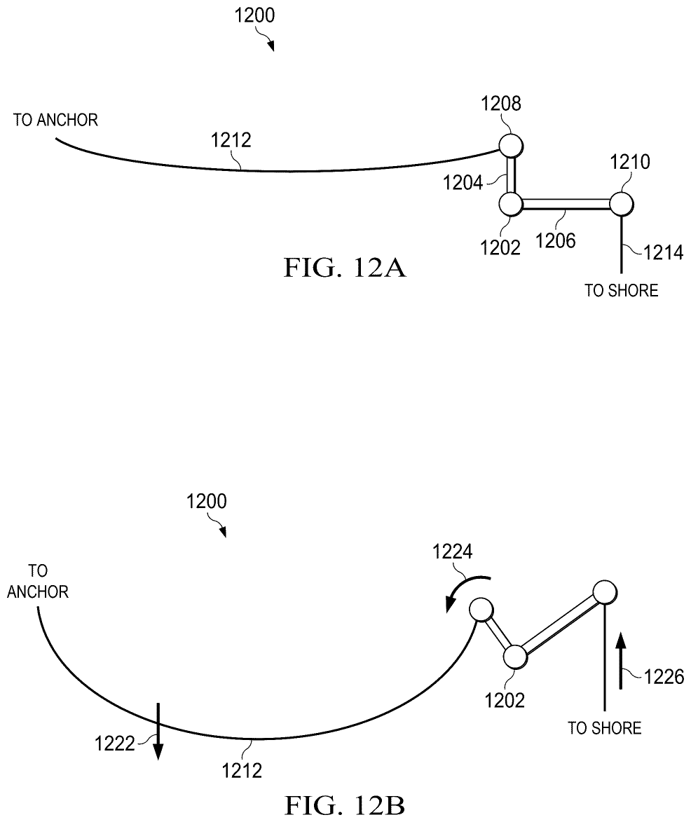

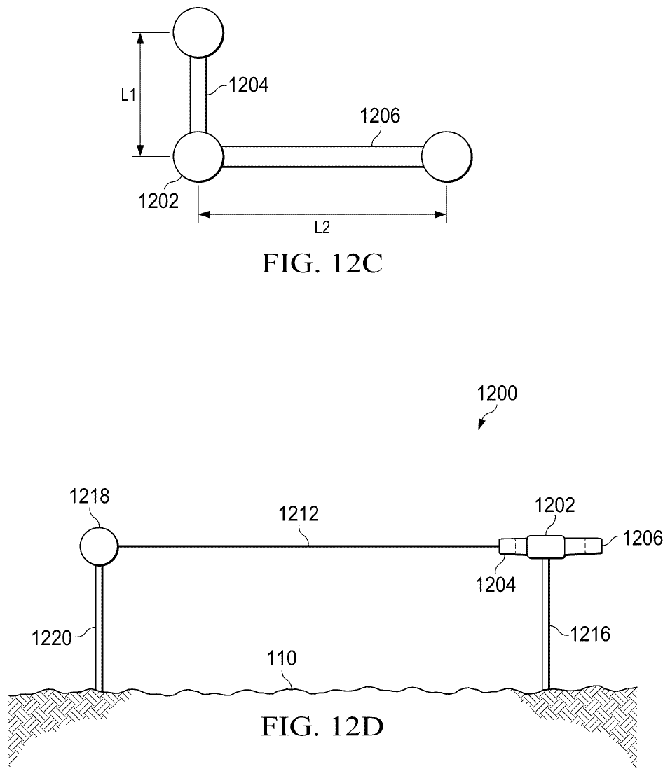

Referring to FIGS. 12A-12D, an environment 1200 illustrates an embodiment of a system that represents at least a portion of the energy harvesting system 102 of FIG. 1. The system includes a pivot point 1202 around which lever arms 1204 and 1206 may rotate. It is understood that the pivot point 1202 may include one or more components (e.g., a bearing, sleeve, and/or other hardware designed to accept a member (e.g., a rod or pin) and allow rotational movement), or may simply be a cavity through which a member is inserted. For example, if the lever arms 1204 and 1206 are joined at the pivot point 1202, the pivot point may be a hole at that location, although a component such as a bearing may be positioned therein to aid in smooth rotation and/or to reduce wear. In other examples, the pivot point 1202 may be a component or assembly to which the levers arms 1204 and 1206 are either removably or permanently coupled.

The end 1208 of the lever arm 1204 may be coupled to one or more lines 1212 that is coupled to an anchor 1218 (FIG. 12D). The end 1210 of the lever arm 1206 may be coupled to one or more lines 1214 that is coupled to an object on the shore (e.g., the energy storage/use system 104 of FIG. 1A). The pivot point 1202 and anchor 1218 may be secured to the bed 110 using posts 1216 and 1220, respectively, and/or lines (not shown). The posts 1216 and 1220 may be driven into the bed 110 or may be coupled to objects having sufficient weight to prevent movement of the pivot point 1202 and anchor 1218 relative to the bed. The lines 1212 and 1214 may be positioned at or near the surface, or may be submerged (e.g., to interact with underwater currents rather than surface waves).

In operation, the line 1212 in FIG. 12A may represent a neutral line position when no wave forces are acting on the line. In FIG. 12B, the line 1212 may represent a line position that occurs when a wave force 1222 is pushing the line towards the shore (e.g., an incoming wave relative to the shore). This force pulls on the line 1212, which in turn rotates the lever arm 1204 around the pivot point 1202 in the direction indicated by arrow 1224. This causes the lever arm 1206 to pivot in the same direction, which results in a pulling motion on the line 1214 as indicated by arrow 1226. The movement of the line 1214 results in a pumping or stroking force at the shore, which may be used directly and/or converted into other forms of energy.

The amount of force generated may vary based on such factors as the length of the line 1212, the number of lines used, the lengths and/or orientation of the lever arms 1204 and 1206, the strength of the waves/currents, and/or other factors. In some examples, the line 1214 may be tensioned from the shore, and/or the pivot point 1202 and/or another component may be tensioned (e.g., via a spring), to aid in resetting the lever arms 1204 and 1206 when the wave force reverses (e.g., an outgoing wave relative to the shore). For example, the line 1214 may be coupled to a device on shore that obtains energy from the movement of the line in the direction of the arrow 1226. The device may naturally apply tension to reverse the stroke caused by the line 1214, thereby aiding in resetting the lever arms 1204 and 1206. In other examples, the orientation of the lever arms 1204 and 1206 and/or the connection points of the lines 1212 and 1214 may be modified to enable energy from an outgoing wave to be captured instead.

As shown in FIG. 12C, the lengths L1 and L2 of the lever arms 1204 and 1206, respectively, may be varied to create different forces on the lines 1212 and/or 1214. For example, shortening and/or lengthening one or both of the lever arms 1204 and 1206 may alter the amount of force on the line 1214 that is generated by the wave force 1222. Accordingly, by selecting particular lengths for the lever arms 1204 and 1206, the system may be configured for optimized operation for a particular shoreline's wave patterns. Generally, the force/motion stroke may be changed to amplify the stroke length or the force by using dissimilar arms for the wave arc line 1212 or the beach stroke line 1214. The lengths L1 and L2 may also be adjusted to prevent undue wear on the lever arms 1204 and 1206, and/or on the lines 1212 and 1214.

The ends 1208 and 1210 may be configured to prevent wear of the lines 1212 and 1214, respectively. For example, the ends of the lines 1212 and 1214 that couple to the ends 1208 and 1210 may include a ball that engages a socket in the respective end 1208 and 1210. The ball may move relatively freely within the socket, reducing the wear that may be caused by a more restrictive (e.g., static) fastening means. It is understood that many different coupling mechanisms may be used to couple the end of a line to another component of the system, and that such mechanisms may be used in any embodiment described herein where applicable. Such mechanisms may include open and closed spelter sockets, open and closed swaged sockets, ball swage assemblies (e.g., plain ball and/or ball shank fittings), ball and joint mechanisms, and/or any other suitable mechanisms and combinations thereof.

In some examples, line wear may be reduced by mitigating fatigue through line adjustment. For example, line fatigue may be mitigated by gradually moving the anchor point of the cable on either end to distribute the fatigue. This may be done with a large loop of cable or a linear adjustment to extra cable on either end that is progressed to distribute the fatigue. Such line fatigue mitigation may be used in any embodiment described herein where applicable.

The line 1212 may be configured with features (e.g., components such as floats and/or fins, and/or shapes such as pockets and/or other features), and such components and features may be attachments and/or built-in to the line. The components and features may increase the surface area of the line in order to create more drag and, accordingly, more pressure on the line from the waves. In some embodiments, marine vegetation (e.g., kelp) may be grown or allowed to grow on the line for similar reasons.

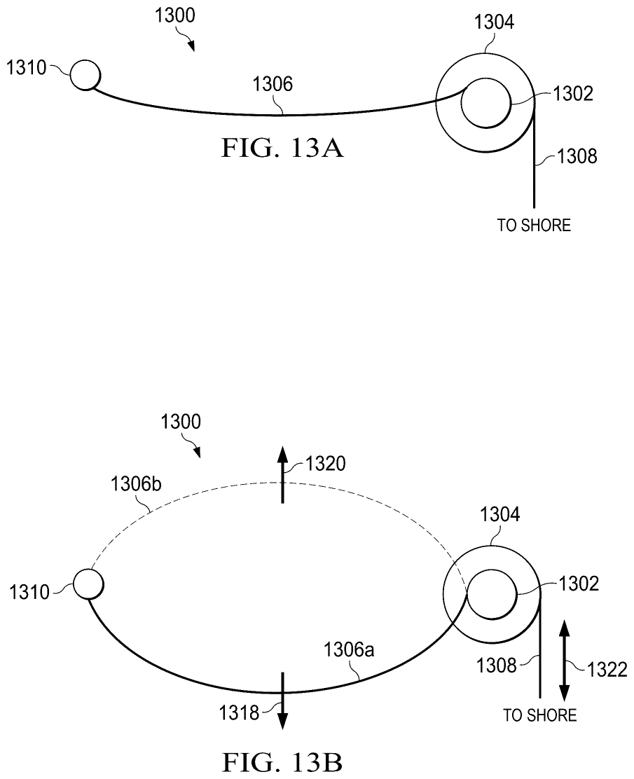

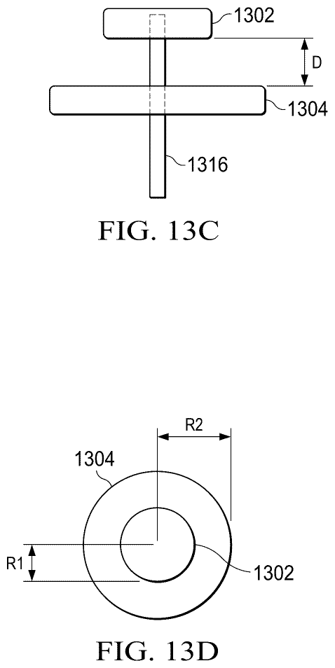

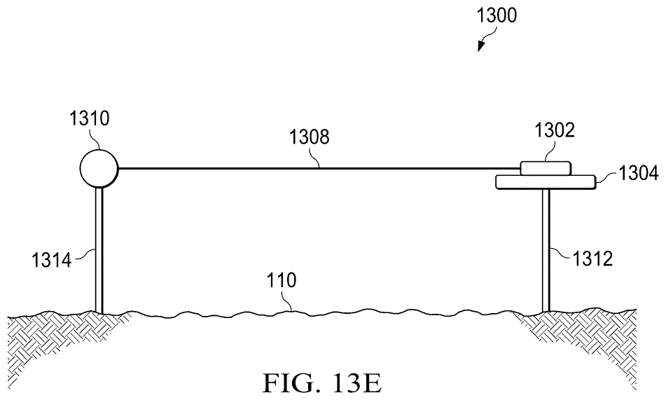

Referring to FIGS. 13A-13E, an environment 1300 illustrates an embodiment of a system that represents at least a portion of the energy harvesting system 102 of FIG. 1. The system includes a pulley 1302 and a pulley 1304. The pulley 1302 is coupled to an anchor 1310 via one or more lines 1306. The pulley 1304 is coupled to a line 1308 that is coupled to an object on the shore (e.g., the energy storage/use system 104 of FIG. 1A). The lines 1306 and 1308 may be positioned at or near the surface, or may be submerged (e.g., to interact with underwater currents rather than surface waves).

The pulleys 1302/1304 and anchor 1310 may be secured to the bed 110 using posts 1312 and 1314, respectively, and/or lines (not shown). The posts 1312 and 1314 may be driven into the bed 110 or may be coupled to objects having sufficient weight to prevent movement of the pulleys 1302/1304 and anchor 1310 relative to the bed. As shown in FIG. 13C, the pulleys 1302 and 1304 may share a common center pin 1316, which may be part of, or otherwise aligned with, the post 1312. The pulleys 1302 and 1304 may be relatively closely spaced or may be separated by a distance D. The distance D may be empty, or may include a bushing or other component(s) designed to keep the pulleys 1302 and 1304 from vertical movement, to aid rotation, and/or to minimize wear. In other examples, the pulleys 1302 and 1304 may not share a common center point and may be offset from one another.

In operation, the line 1306 illustrated in FIG. 13A may represent a neutral line position when no wave forces are acting on the line. Line 1306a (FIG. 13B) may represent a line position that occurs when a wave force 1318 is pushing the line towards the shore (e.g., an incoming wave relative to the shore). Line 1306b (FIG. 13B) may represent a line position that occurs when a wave force 1320 is pushing the line away from the shore (e.g., an outgoing wave relative to the shore). This back and forth movement results in a pumping or stroking force at the shore as indicated by arrow 1322. The amount of force generated may vary based on such factors as the length of the line 1306, the number of lines used, the diameters of the pulleys 1302 and 1304, the strength of the waves/currents, and/or other factors.

As shown in FIG. 13D, the pulleys 1302 and 1304 have a radius of R1 and R2, respectively, each of which may be modified to change the behavior of the system. Generally, the force/motion stroke can be changed to amplify the stroke length or the force by using dissimilar pulleys (e.g., pulleys having different radii) for the wave arc line 1306 or the beach stroke line 1308.

The line 1306 may be configured with features (e.g., components such as floats and/or fins, and/or shapes such as pockets and/or other features), and such components and features may be attachments and/or built-in to the line. The components and features may increase the surface area of the line in order to create more drag and, accordingly, more pressure on the line from the waves. In some embodiments, marine vegetation (e.g., kelp) may be grown or allowed to grow on the line for similar reasons.

Referring to FIG. 14, one embodiment of a device 1400 is illustrated that represents at least a portion of the energy harvesting system 102 of FIG. 1. The device 1400 may provide a low profile, completely submerged replacement for a water wheel using articulated paddles to drive a belt. The device 1400 may rest on multiple (e.g., four) spiked feet under its own weight with minimal contact with the sea/river bed and, assuming the water level is sufficient, may not be visible above the water's surface. The device 1400 operates by opening paddles into the water's flow to create a fish friendly sweeping action through the water, rather than turbine blades that follow a chopping action through the water. In some examples, by keeping the weight and cost down and/or by making other modifications, it is hoped that this and other designs of the energy harvesting system 102 described herein will be able to compete with fossil fuel for cost per kilowatt.

The device 1400 includes a body 1402 that may include be shaped in at least some areas to redirect moving water, such as by a deflector face 1404. The deflector face 1404 may redirect water (moving in the direction indicated by arrow 1426) up and over the top of the device 1402, which in turn may increase the flow rate of water across the top of the device. The body 1402 may support multiple pulleys (e.g., guide wheels) 1406a and 1406b. The pulleys 1406a and 1406b may be of many different shapes, including circular or hexagonal. The pulleys 1406a and 1406b support a belt 1408 that is configured to rotate around the guide wheels.

Braces 1410a and 1410b may support the pulleys 1406a and 1406b respectively, and the braces may be formed as part of the body 1402 or may be separate components that are coupled to the body. A block 1412 may be positioned inside the belt 1408 to add weight and/or additional support to the device 1400. For example, the block 1412 may be made of concrete to add weight to, and thereby minimize movement of, the device 1400. The block 1412 may be supported by braces 1414a and 1414b.

Flexible paddles 1416 may be coupled to the belt 1408. The paddles 1416 may be formed by a single sheet of flexible material or may be made of sections 1418 that are configured to allow some movement between the sections. For example, the sections 1418 may be coupled by bands that enable relative movement between the paddles 1416, or a paddle may be made of a single piece of material that includes channels or is otherwise scored to enable relative movement between different sections of the paddle. Straps 1420 may be coupled to the belt 1408 and each paddle 1416 to limit the movement of the paddles away from the belt. The length of the straps 1420 and/or the locations at which the straps are coupled to the belt 1408 and/or the paddles 1416 may be selected to provide a desired angle of each paddle relative to the belt.

In operation, when water is moving in the direction illustrated by arrow 1426, the paddles 1416 at the top of the device 1400 are pushed away from the belt 1408 until restrained by their respective straps 1420. This presents a flat or angled panel surface to the water and creates resistance to the water's movement, which results in rotation of the belt 1408. This rotation in turn rotates the pulley 1406a and a coupled drive shaft 1422 as indicated by arrow 1424. The drive shaft 1422 may be flexible or rigid. As the belt 1408 and the attached upright paddles 1416 are pushed by the current in the direction of the pulley 1406b and then underneath the block 1412, the paddles are forced to lay substantially flat (e.g., with their respective straps between the paddle and the belt) due to the direction of the water's movement. The torque caused by the rotating belt may be transferred by the drive shaft 1422 to the energy storage/use system 104.

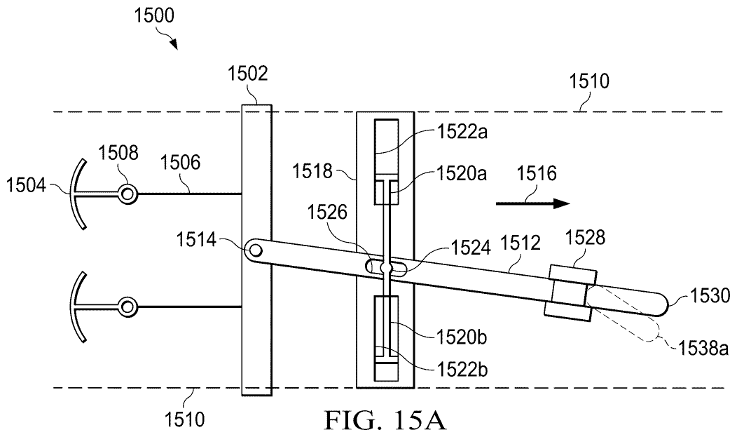

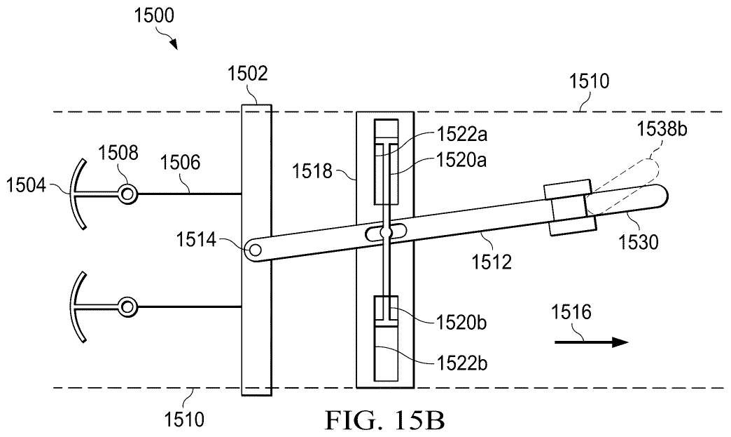

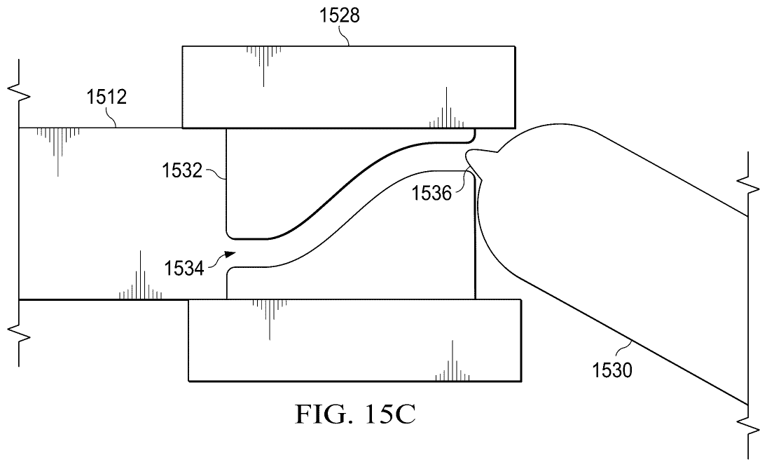

Referring to FIGS. 15A and 15B, one embodiment of a system 1500 is illustrated that represents at least a portion of the energy harvesting system 102 of FIG. 1. The system 1500 may include a pivot bar 1502 that is coupled to a sea/river bed using one or more anchors 1504. The anchor 1504 may be coupled to the pivot bar 1502 using one or more lines 1506, and one or more components 1508 (e.g., buoys, weights, tensioners, and/or any other type of component) may be coupled to, or incorporated into, the line. The pivot bar 1502 may be secured on either end (e.g., coupled to the shore 1510 or to posts and/or other fixed positions within the flow).

One end of a lever arm 1512 is pivotably coupled to the pivot arm 1502 at pivot point 1514, while the other end is positioned downstream (as indicated by the direction of water flow represented by arrow 1516). The lever arm 1512 may float on the surface or, in some embodiments, may be partially or completely submerged. When submerged, it is understood that some or all of the other components of the system 1500 may be submerged as well, such as the pivot bar 1502.

An energy harvesting bar 1518 may be positioned substantially perpendicular to the flow (and substantially parallel to the pivot bar 1502) between the upstream and downstream ends of the lever 1512. The bar 1518 may include one or more pistons 1520a and 1520b that are positioned within piston chambers 1522a and 1522b, respectively. The pistons 1520a and 1520b may be part of separate piston assemblies, or may form parts of a single piston assembly (e.g., a duplex piston pump). The pistons 1520a and 1520b may be coupled to a drive pin 1524 (e.g., a pin, ball, or other component) that slidably engages a channel or opening 1526 (e.g., a slot or notch) in the lever arm 1512.

The downstream end of the lever arm 1512 may have a mechanism 1528 (e.g., a water wheel) coupled to the lever arm to move a rudder 1550. With additional reference to FIG. 15C, the water wheel 1528 may include a central drum 1532 having a grooved track 1534 or may drive (e.g., using a gear) a similar grooved track. The rudder 1530 may include a protrusion or other engagement shape 1536 to engage the grooved track 1534.

As illustrated in FIGS. 15A and 15B, the grooved track 1534 causes the rudder 1530 on the lever arm 1512 to offset alternately from one side to the other. For example, in FIG. 15A, the rudder 1530 may move from a neutral position (e.g., the solid line representing rudder 1530) to a position illustrated by dotted line 1538a. Similarly, in FIG. 15B, the rudder 1530 may move from a neutral position (e.g., the solid line representing rudder 1530) to a position illustrated by dotted line 1538b.

In operation, this causes the lever arm 1512 to slowly swing from one side of the flow to the other (e.g., between the positions illustrated in FIG. 15A and FIG. 15B) with very high torque but low speed. As this swing occurs, the pistons 1520a and 1520b are worked by the lever arm 1512 by means of the drive pin 1524. The force generated by the rudder 1530 may be exaggerated by the leverage to pump water into a hose for delivery, for power generation through a turbine, or as otherwise described herein (e.g., to the energy storage/use system 104).

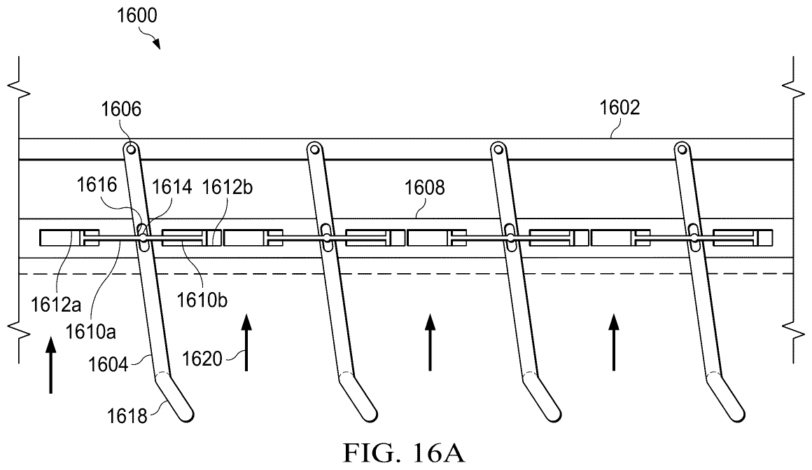

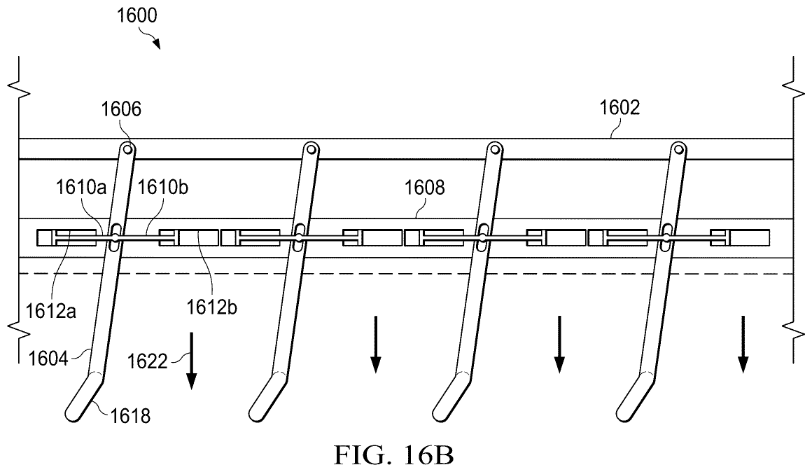

Referring to FIGS. 16A and 16B, one embodiment of a system 1600 is illustrated that represents at least a portion of the energy harvesting system 102 of FIG. 1. The system 1600 may be similar to the system 1500 of FIGS. 15A-15C, but may be more suitable for use with a body of water that displays usable tidal shifts and/or a wavefront (e.g., a sea or ocean), than a river or similar directed flow current as illustrated with FIGS. 15A and 15B. The system 1600 may include one or more pivot bars 1602 that are positioned on shore or above water (e.g., on stilts, platforms, and/or other raised structures). One end of a lever arm 1604 is pivotably coupled to the pivot arm 1602 at pivot point 1606, while the other end is positioned offshore (or further offshore if the pivot bar 1602 is positioned above the water). The lever arm 1604 may float on the surface or, in some embodiments, may be partially or completely submerged. When submerged, it is understood that some or all of the other components of the system 1600 may be submerged as well, such as the pivot bar 1602.

One or more bars 1608 may be positioned substantially perpendicular to the tidal flow/waves (and substantially parallel to the pivot bar 1602) between the ends of the level arm 1604. The bar 1608 may include one or more pistons 1610a and 1610b that are positioned within piston chambers 1612a and 1612b, respectively. The pistons 1610a and 1610b may be part of separate piston assemblies, or may form parts of a single piston assembly (e.g., a duplex piston pump). The pistons 1610a and 1610b may be coupled to a drive pin 1614 (e.g., a pin, ball, or other component) that slidably engages a channel or opening 1616 (e.g., a slot or notch) in the lever arm 1604.

A rudder 1618 is positioned on the offshore end of the lever arm 1604. While not shown, it is understood that the lever arm 1604 may have a mechanism coupled to the lever arm to move the rudder 1618 (e.g., as described with respect to FIG. 15C, although the configuration may be different due to the reversing flow directions) or the rudder may be fixed. In operation, as illustrated in FIG. 16A, inward surge (indicated by arrow 1620) pushes the fixed rudders to the right. As illustrated in FIG. 16B, outward surge (indicated by arrow 1622) pushes the fixed rudders to the left. As the surges may not be equal, a mechanism (e.g., a restoring spring or a wheel in a V track) may be used to compensate as needed.

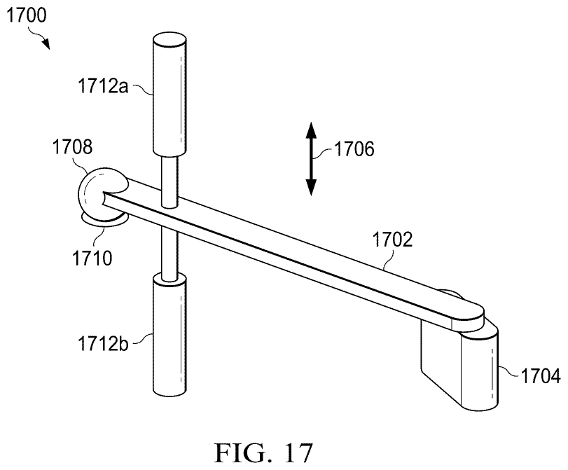

Referring to FIG. 17, one embodiment of a portion of a system 1700 is illustrated that represents at least a portion of the energy harvesting system 102 of FIG. 1. In the present example, the system 1700 may be used with embodiments of the system 1600 of FIGS. 16A and 16B. In the present example, one end of a lever arm 1702 may be coupled to a bar 1704 in a manner that allows the lever arm (alone or in conjunction with the bar) to move vertically as illustrated by arrow 1706. For example, if the lever arm 1702 is the lever arm 1604 of FIGS. 16A and 16B, the lever arm may be coupled to the bar 1704 in a manner that enables both pivoting and vertical movement, or the bar 1704 may move vertically while the lever arm is pivotably coupled thereto.

A float 1708 (e.g., a buoy) may be coupled to the other (e.g., the offshore) end of the lever arm 1702 on or near the surface of the water (indicated by area 1710). As the water level rises and lowers, the lever arm 1702 also rises and lowers. One or more pistons 1712a and 1712b coupled to the lever arm 1702 move vertically with the lever arm. Although not shown, it is understood that pistons 1712a and 1712b may be positioned relative to piston chambers as shown with respect to FIGS. 16A and 16B. In operation, the vertical orientation of the pistons 1712a and 1712b, and the vertical movement of the lever arm 1702, may enable the harvesting of energy in the vertical direction from the wave surge.

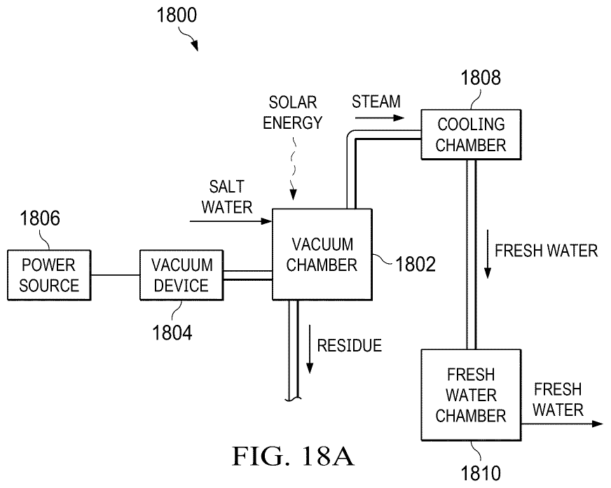

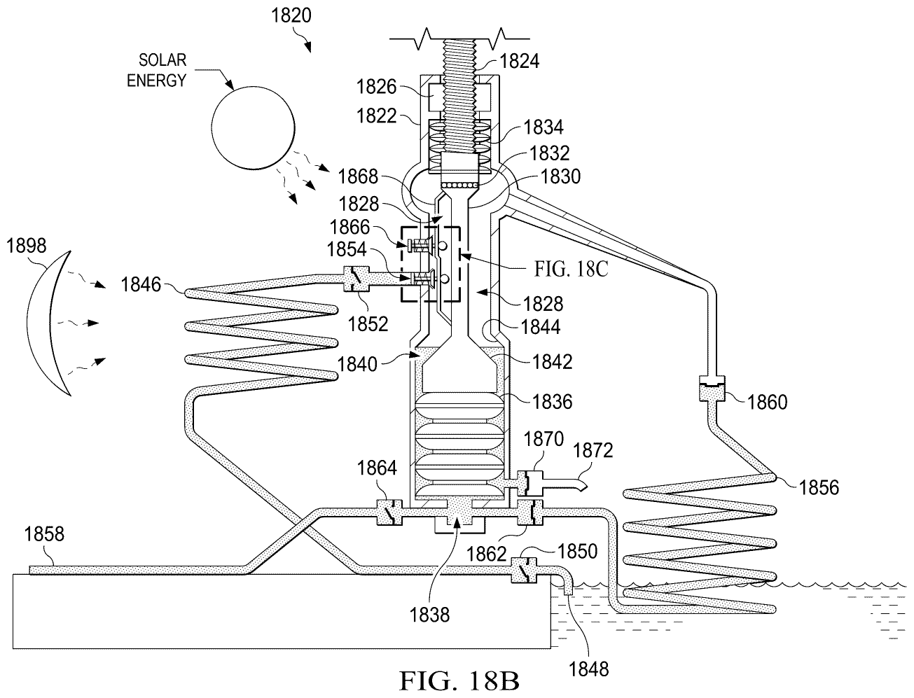

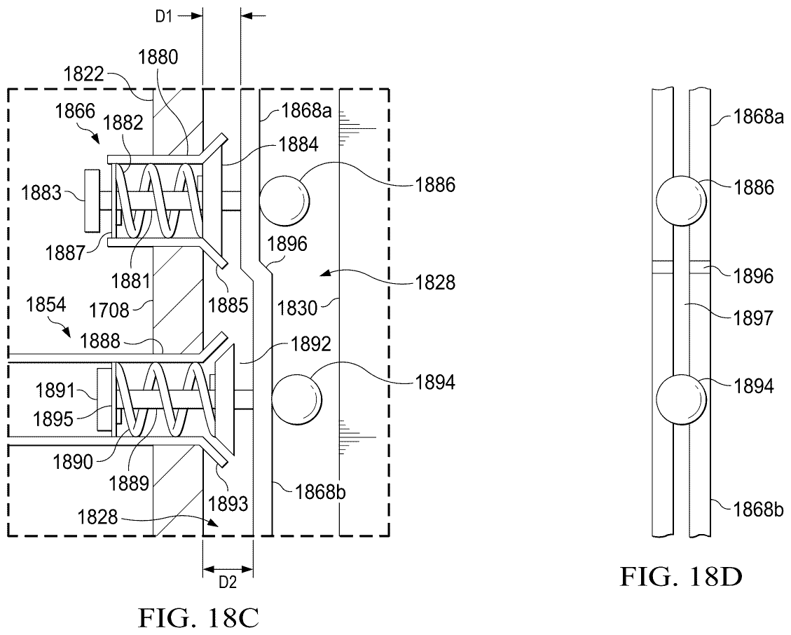

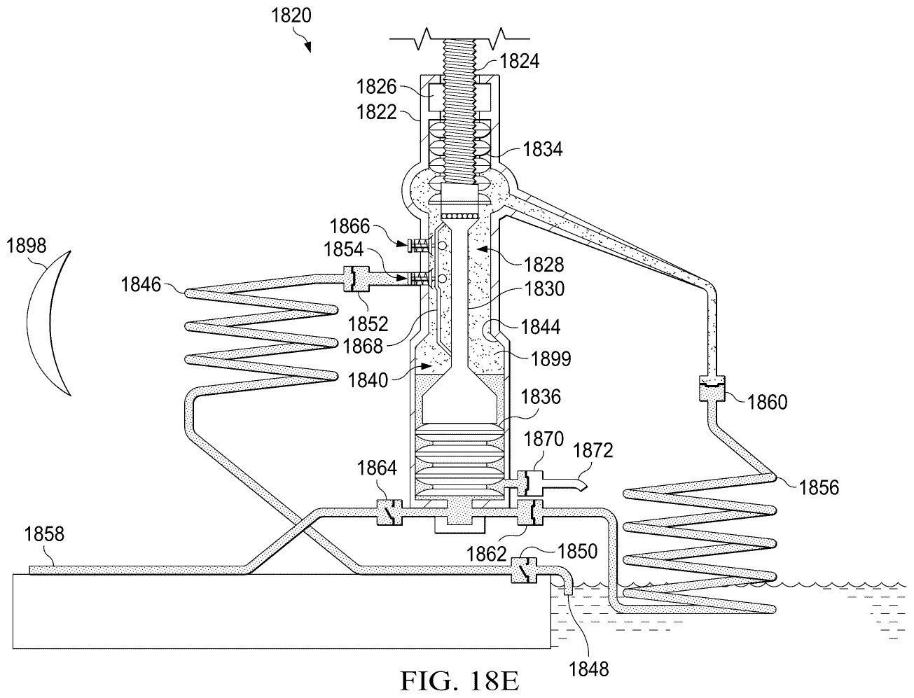

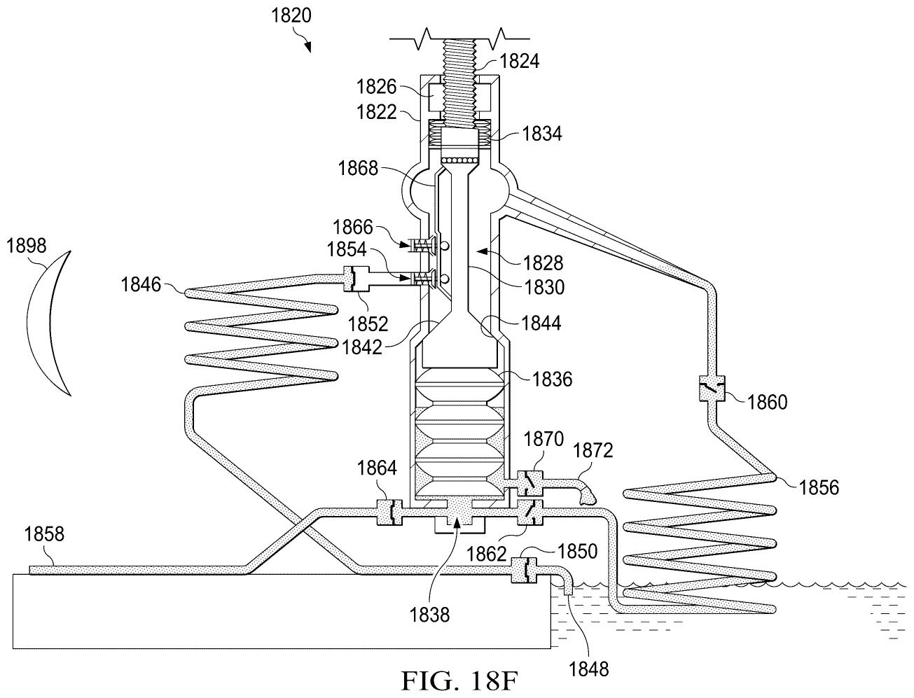

Referring to FIG. 18A, one embodiment of a desalination system 1800 is illustrated. For example, the desalination system 1800 may form all or part of the desalination system 202 of FIG. 2. In the present example, the desalination system 1800 may use solar energy to provide heat to enable boiling water for desalination purposes, and a vacuum may be used to lower the temperature needed for the water's boiling point. Some or all of the power for the vacuum may be provided by an energy harvesting system, such as the energy harvesting system 102 of FIGS. 1A-1C and as disclosed in other embodiments herein.

In operation, water to be desalinated (e.g., salt water) may be provided to a vacuum chamber 1802. The vacuum chamber 1802 may be exposed to solar energy and/or connected to a heat pump and/or one or more others systems that provide heat to the contents of the vacuum chamber. Once water is inside the vacuum chamber 1802, a vacuum device 1804 may begin to evacuate air from the vacuum chamber. In the present example, the vacuum device 1804 may be powered by a power source 1806, which may be an energy harvesting system as disclosed in the present application. Such power may be incrementally provided. For example, if the power source 1806 is the energy harvesting system of FIG. 11, the power may be received for each stroke of the line 1106 caused by wave energy. Accordingly, the vacuum device 1804 may include worm screws, ratchets, pistons, bellows, bags, and/or any other systems and/or components, including combinations thereof, that may be used to receive energy incrementally and use that energy to increase the level of vacuum in the vacuum chamber 1802.

As the water boils, desalinated water may be produced. Once the vacuum cycle is complete, positive pressure that occurs as the vacuum is released may be used to force steam and/or water out of the vacuum chamber 1802. Steam may enter a cooling chamber 1808, by force and/or through natural convective processes, and then condensed water may fall into a freshwater chamber 1810 as the steam cools. Residue in the vacuum chamber 1802 (e.g., salt water and/or salt particles) may be removed. In some examples, the same stroke (e.g., an upstroke if the downstroke creates the vacuum force) may be used to eject both the residue from the vacuum chamber 1802 and the freshwater from the freshwater chamber 1810.

If particles are still present in the water, the water in the freshwater chamber 1810 may sit until the particles have fallen, and/or particles may be otherwise filtered in the vacuum chamber 1802, the pipe(s) leading from the vacuum chamber to the freshwater chamber, and/or in the freshwater chamber. In some examples, a settling tank (not shown) may be used as an intermediate tank between the vacuum chamber 1802 and the freshwater chamber 1810 to allow suspended particles to fall to the bottom of the tank.

It is understood that each component of the system 1800 may represent multiple components. Residue, including salt and/or other minerals, may be used, discarded (e.g., in an environmentally friendly manner that does not overwhelm the discard area), and/or disposed of in other ways.

In some embodiments, some or all of the wave energy may be allocated to different parts of the system 1800 at different times. For example, the amount of energy needed to create a vacuum may be larger than the amount of energy needed to pump water into or out of the vacuum chamber 1802. In addition, there may be times that are optimal for certain system states, such as achieving a maximum vacuum when the temperature from solar energy is at a peak (e.g., the middle of the day rather than at night). Accordingly, energy may be allocated across the system 1800 based on solar sensor information, thermometers, clock mechanisms, and/or any other information, process(es), and/or mechanism(s) that may be configured to determine how to efficiently use the wave energy to accomplish the system's tasks.

In embodiments where the energy is also used for irrigation (e.g., pumping fresh water), potable water supply, and/or other purposes, such energy efficiencies may be configured to include such uses. For example, energy may be directed to creating the vacuum during the hottest period of the day, and then used for irrigation at times of lower solar energy (e.g., early morning, late afternoon, evening, and/or night). In this manner, the productive use of wave energy may be maximized for the system 1800. It is understood that energy allocation may be divided among multiple uses. For example, a relatively low amount of energy may be allocated to vacuum creation in the morning, while a relatively high amount of energy may be allocated to irrigation. As the day progresses and the temperature increases, irrigation may be slowed or stopped as more energy is allocated to creating the vacuum to maximize the efficiency of the desalination process.

Referring to FIGS. 18B-18F, another embodiment of a desalination system 1820 is illustrated. For example, the desalination system 1820 may form all or part of the desalination system 202 of FIG. 2. In the present example, the desalination system 1820 may use solar energy to provide heat to enable boiling water for desalination purposes, and a vacuum may be provided using mechanical power to lower the temperature needed for the water's boiling point. Some or all of the power for the vacuum may be provided by an energy harvesting system, such as the energy harvesting system 102 of FIGS. 1A-1C and as disclosed in other embodiments herein.

Referring primarily to FIG. 18B, the desalination system 1820 has a body 1822 that includes multiple chambers. A mechanical device 1824 is configured to receive mechanical energy from an energy harvesting system (not shown) and is at least partially contained within a chamber 1826. In the present example, the mechanical device 1824 may be a ratchet that moves in one direction before being released to reset, with wave energy driving the rachet over time. It is understood that the mechanical device 1824 may be implemented in many different ways, and that a rachet is one possible implementation.

A vapor chamber 1828 is positioned beneath the chamber 1826, and includes a shaft 1830 positioned therein. An upper portion of the shaft 1830 may be coupled to the rachet 1824, with the rachet providing mechanical power to drive the shaft 1830. Ball bearings 1832 may be positioned between the ratchet 1824 and the shaft 1830 to enable the ratchet to rotate relative to the shaft without rotating the shaft.

A bellows 1834 may be coupled to an upper portion of the shaft 1830 and may be used to prevent a seal from forming between the vapor chamber 1828 and the chamber 1826. A bellows 1836 may be coupled to a lower portion of the shaft 1830 and may abut a chamber 1838 that is open to, and may be acted upon by, the bellows 1836. A lower chamber 1840 may be open to the vapor chamber 1828 when a shoulder 1842 of the shaft 1830 is below a corresponding shoulder 1844 of the chamber 1840.

A heating coil 1846 may obtain water from an inlet 1848 and supply the water to the vapor chamber 1828. Supply valves 1850, 1852, and 1854 may be used to control the flow of water through the heating coil 1846. It is noted that all valves described in the present embodiment may be self-operating based on either pressure or the position of the shaft 1830. A cooling coil 1856 may intake vapor from the vapor chamber 1828 and provide water to an outlet 1858. A nonreturn valve 1860, a cooling coil valve 1862, and an outlet valve 1864 may be used to control the flow of fluid through the cooling coil 1856. A valve 1868 may provide a passage from the outside of the body 1822 to the vapor chamber (e.g., for air). A valve 1870 may control an overflow outlet 1872. In some embodiments, one or more reflectors 1898 may be used to direct solar energy towards the heating coil 1846.

With additional reference to FIGS. 18C and 18D, the valves 1854 and 1866 may be controlled by an arm 1868 coupled to the shaft 1830. The position of the valves 1854 and 1866 relative to the body 1822 does not change, while the position of the arm 1868 relative to the body does change as the shaft 1830 moves up and down. Accordingly, as the shaft 1830 moves up and down, the valves 1854 and 1866 may be opened and closed based on their position along the arm 1868.

As shown in FIGS. 18C and 18D, the valve 1866 may include a valve body 1880 that contains a rod 1881 and a spring 1882. An end cap 1883 may be coupled to an exterior side of the rod 1881 and a plug 1884 may be coupled along a portion of the rod position within the vapor chamber 1828. A shoulder 1887 that is part of the valve body 1880 may be used to provide a stopping point for the end cap 1883 to prevent the end cap from entering the valve body and to provide a rest for the spring 1882. The spring 1882 may be captured between the shoulder 1887 and the plug 1884. The plug 1884 is in the closed position as shown, with sloped shoulders of the plug abutting a sloped feature 1885 that may be part of the body 1822 or part of the valve 1866. The rod 1881 continues through the arm 1868 to an end cap (e.g., a ball) 1886.

Similarly, the valve 1854 may include a valve body 1888 that contains a rod 1889 and a spring 1890. An end cap 1891 may be coupled to an exterior side of the rod 1889 and a plug 1892 may be coupled along a portion of the rod position within the vapor chamber 1828. A shoulder 1895 may be used to provide a stopping point for the end cap 1891 to prevent the end cap from entering the valve body and to provide a rest for the spring 1890. The spring 1890 may be captured between the shoulder 1895 and the plug 1892. The plug 1892 is in the open position as shown, with a gap between sloped shoulders of the plug and a sloped feature 1893 that may be part of the body 1822 or part of the valve 1854. The rod 1889 continues through the arm 1868 to an end cap (e.g., a ball) 1894.

The arm 1868 may include an upper portion 1868a and a lower portion 1868b, with the upper portion being closer to the valves 1866 and 1854 than the lower portion. The upper and lower portions 1868a and 1868b are joined by a sloped or angled surface 1896. As shown, the valve 1866 is currently opposite the upper portion 1868a and the valve 1854 is opposite the lower portion 1868b. The distance D1 of the upper portion 1868a from the valves 1866 and 1854 means that a valve that is opposite the upper portion will remain closed. In contrast, the distance D2 of the lower upper portion 1868a from the valves 1866 and 1854 means that a valve that is opposite the lower portion will be open because the ball corresponding to the valve will be pulled towards the arm, thereby pulling the corresponding plug away from the valve body.

Accordingly, each of the valves 1866 and 1854 may be opened and closed based on the relative position of each valve to the shaft 1830 to which the arm 1868 is attached. An opening (e.g., a slot) 1897 (FIG. 18D) in the arm 1868 may be provided to enable the shaft 1830 to move relative to the rods 1881 and 1889.

Referring specifically to FIG. 18B, a portion of the operation of the desalination system 1820 is illustrated. The vapor chamber 1828 may be filled as follows. The shaft 1830 drops, which may happen relatively slowly due to the wave action power mechanism, as the ratchet 1824 is engaged. The vent 1866 is closed (due to the position of the arm 1868) to enable suction to occur in the vapor chamber 1828. The supply valves 1850, 1852, and 1854 are open to provide water to the vapor chamber 1828 via the heating coil 1846, with the supply valve 1854 open due to the position of the arm 1868. The overflow valve 1870 is shut to close the overflow outlet 1872. The nonreturn valve 1860 is closed.

At least partially emptying the lower chamber 1840 may occur during this portion of the process. The bellows 1836 are undergoing compression due to the shaft 1830 dropping. The valve 1862 is closed, blocking off the cooling coil downstream of that point. The outlet valve 1864 is open. The pressure of the bellows 1836 may force fluid in the coiling cool downstream of the cooling coil valve 1862 through the outlet 1858.

Referring specifically to FIG. 18E, a portion of the operation of the desalination system 1820 is illustrated. During a vacuum stroke within the vapor chamber 1828, both the vent valve 1866 and the supply valves 1852 and 1854 are closed. The shaft 1830 continues to drop. The water in the lower chamber 1840 boils off, resulting in water vapor (as indicated by circles 1899) that fills the vapor chamber.

The emptying of the lower chamber 1840 may continue during this portion of the process. The bellows 1836 are undergoing compression due to the shaft 1830 dropping. The valve 1862 is closed, blocking off the cooling coil downstream of that point. The outlet valve 1864 is open. The pressure of the bellows 1836 may force fluid in the coiling cool downstream of the cooling coil valve 1862 through the outlet 1858.

In some embodiments, in addition to using vacuum to lower the boiling point, additional processes may be used. For example, a compression/tension cycle of elastocalorics may be used to add heat to the boiling process and provide cooling for the condensing process in subsequent cycles. Various gases and/or fluids may also be added to, or present within, the desalination system 1820 to aid in the heating and/or cooling processes.

Referring specifically to FIG. 18E, a portion of the operation of the desalination system 1820 is illustrated for a flush. The shaft 1830 rises until its shoulder 1842 abuts the shoulder 1844. The vent 1866 and supply vent 1854 are open, but the heating coil 1846 is closed at the supply valve 1852. The nonreturn valve 1860 is open to allow the desalinated water that was previously in vapor form to drop into the cooling coil 1856. The overflow valve 1870 is open to allow waste (e.g., brine) from the desalination process to exit the body 1822. Some desalinated water may drop to the lower chamber.

This process may repeat, with mechanical energy driving the shaft 1830 down until it is released to reset. Because the valves and bellows are actuated based on the various pressures and/or position of the shaft 1830, the desalination system 1820 may be used in areas with no electricity. As stated elsewhere herein, the system 1820 may receive power from many different mechanical power sources, and may be used for processes other than desalination.

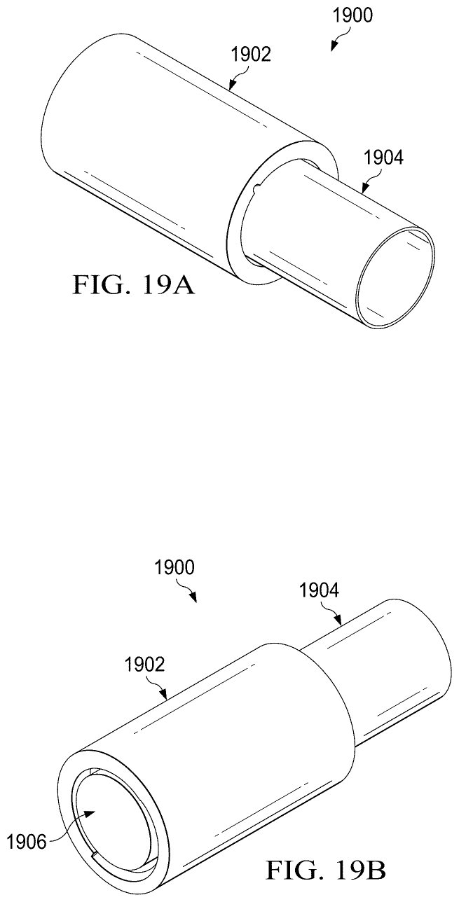

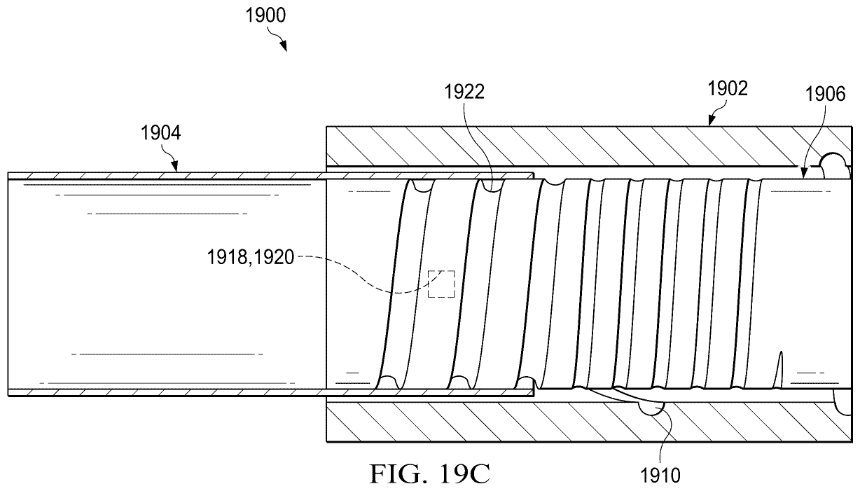

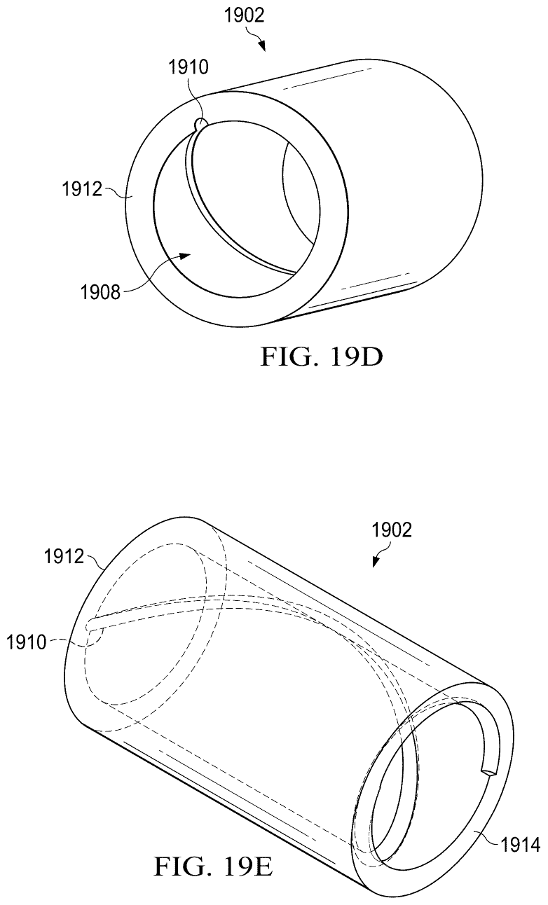

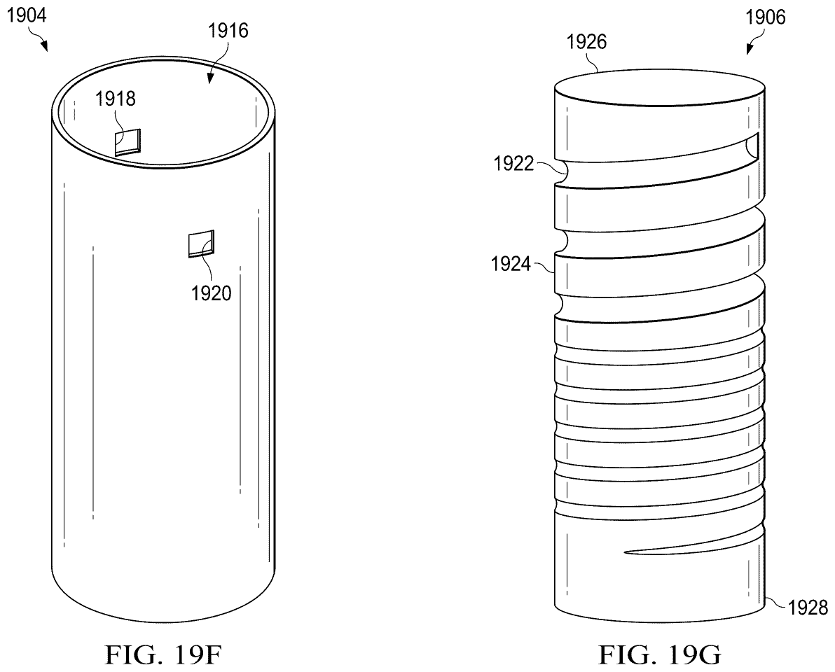

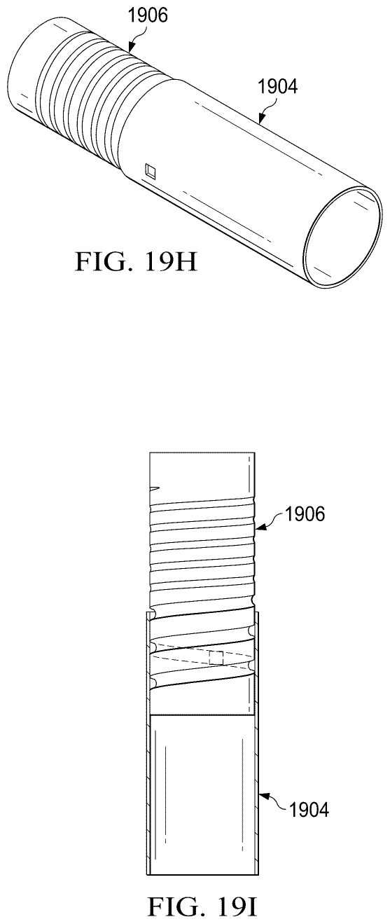

Referring to FIGS. 19A-19I, one embodiment of a mechanism 1900 is illustrated that may be used as the mechanical device 1824 of FIG. 18B. The mechanism 1900 is a ball screw design that pushes the bellows 1836 (FIG. 18B) down and maintains slower compression to maintain pressure for boiling, and then releases rapidly which also ejects freshwater. As shown in FIGS. 19A-19C, the mechanism 1900 may include an outer sleeve 1902, a ball sleeve 1904, and an inner shaft 1906.

With additional reference to FIGS. 19D and 19E, the outer sleeve 1902 may be substantially cylindrical with a cavity 1908 formed therein. The wall of the cavity 1908 may include a helical groove 1910 that runs from one end 1912 of the sleeve to the other end 1914. It is understood that the groove 1910 and other grooves shown herein are for purposes of example and may be of consistent width and/or depth, may be of varying width and/or depth, may have more or less depth, may have many different widths, may have greater or lesser pitch, may be spirals with differing radii, may circle more or fewer times, may be positioned differently, and/or may be implemented in many different ways.

With additional reference to FIG. 19F, the ball sleeve 1904 may be substantially cylindrical with a cavity 1916 formed therein. One or more openings 1918 may be present in the ball sleeve 1904 to provide accessibility for one or more ball bearings (not shown).

With additional reference to FIG. 19G, the inner shaft 1906 may be substantially cylindrical. A helical groove 1922 may run around the surface of the inner shaft 1906. In the present embodiment, the crest 1924 may narrow as the groove 1922 is followed from one end 1926 of the inner shaft 1906 to the other end 1928.

In operation, the ball sleeve 1904 may carry a ball bearing in each of the openings 1918/1920 and when rotated, the inner shaft 1906 may be pushed down. At the bottom, the ball bearings may push to the outer portion of the ball sleeve 1904 and engage the outer sleeve 1902 that has a helix that will ramp up progressively on the releasing motion. In some embodiments, the groove 1922 may have a consistent depth and width until the fully compressed position where the ball sleeve 1904 pushes the ball to the outer sleeve 1902 and transfers the load.

It is understood that the desalination systems 1800 of FIGS. 18A and 1820 of FIG. 18B may be used with fluids other than water, may be applied to other distillation processes, and/or may be powered using other sources of energy. Such systems may be viewed as a mechanical two or four stroke fluid processor that could distill any fluid. Examples of such fluids may include polluted river water, water used for fracking, and irrigation water that is cleaned and/or pumped using wind power.

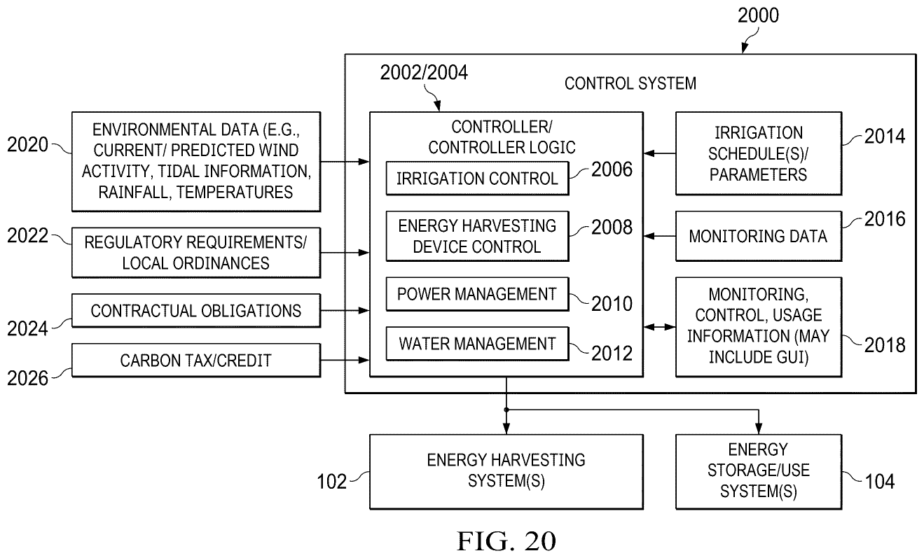

Referring to FIG. 20, one embodiment of a control system 2000 is illustrated. The control system 2000 may be provided, for example, by a controller 2002, which may execute controller logic 2004. The controller 2002 may be a local controller, a remote controller, and/or a combination thereof. The controller logic 2004 may be locally stored (e.g., in a memory that is part of, or directly coupled to, the controller 2002), received via a network connection, and/or may be a combination of locally stored and remote instructions. The control system 2000 may be used to monitor, control, and/or otherwise interact with the energy harvesting system 102 and/or the energy storage/use system 104. In some embodiments, the controller 2002 may control multiple energy harvesting systems 102 and/or energy storage/use systems 104, and may coordinate irrigation and/or energy management across such systems.

For purposes of example, the control system 2000 is used for both the energy harvesting system 102 and the energy storage/use system 104, but it is understood that various components and/or functions described herein may be combined, separated, and/or otherwise structured in many different ways. For example, the particular structure of the control system 2000, including various components and/or functions, may depend on how the energy harvesting system 102 and the energy storage/use system 104 are deployed (e.g., as a single system or as separate systems). Although shown as separate from the energy harvesting system 102 and the energy storage/use system 104, it is understood that the control system 2000 may be part of one or both of the systems 102 and 104.

The controller logic 2004 may include irrigation control 2006, energy harvesting system control 2008, and/or energy management 2010. Irrigation control 2006 may be used to control one or more irrigation systems (e.g., one or more pumps for supplying the irrigation system 208 of FIG. 2). Water usage, timing, and/or other functions may be controlled to provide water. Irrigation control may incorporate irrigation schedules and parameters 2012, environmental data 2018 (e.g., current and/or predicted wind activity, tidal information, rainfall, temperatures, and/or storm warnings), and/or other information.

Energy harvesting system control 2008 may be used to control one or more energy harvesting systems. Such control may include managing buoyancy and orientation if such features are available. Power management 2010 may be used to ensure adequate power is available for desalination and/or irrigation when needed and may regulate power use for high priority components if insufficient power is available for scheduled irrigation and/or other functions, and may include stored energy levels. Water management 2012 may be used to monitor and control water availability, including stored water levels. Such stored energy and water may be used to smooth out distribution to ensure more dependable delivery.

Monitoring data 2016 may be obtained from sensors coupled to the energy harvesting system(s) and the energy storage/use system(s). For example, sensors may be used to detect faults, power fluctuations and/or failures, leaks, desalination problems (e.g., water for irrigation is not sufficiently desalinated), insufficient pressure or pressure that is too high, battery malfunctions, vibrations, water tank levels, and/or other software and/or hardware states and/or issues. Sensor data may be monitored in real time, stored, analyzed, sent to other devices, and/or otherwise used to control and maintain the operation of the monitored systems.

Monitoring, control, and/or usage information 2018 may be accessed via a graphical user interface (GUI). The GUI may be local and/or remote, and may allow remote configuration of the control system 2000, including setting irrigation schedules and parameters 2014. The GUI may also be used to access monitoring data 2016, and to enable user control of the energy harvesting system(s) 102 and the energy storage/use system(s) 104.

Information regarding environmental data 2020 (e.g., current and predicted wind activity, tidal information, rainfall, and/or temperatures), regulatory requirements/local ordinances 2022, contractual obligations 2024, and/or carbon taxes/credits 2026 may be used as inputs to the control system 2002 in some embodiments. Such inputs may be direct or indirect (e.g., entered indirectly as part of the irrigation schedule/parameters 2012).

It is understood that not all energy harvesting systems described herein may use the control system 2000. Instead, some energy harvesting systems may be purely mechanical and may rely on manual adjustments to ensure proper functionality. Accordingly, the implementation of a particular energy harvesting system may depend on many factors, and the presence of, and/or functionality provided by, an energy harvesting system may be based on the particular implementation.

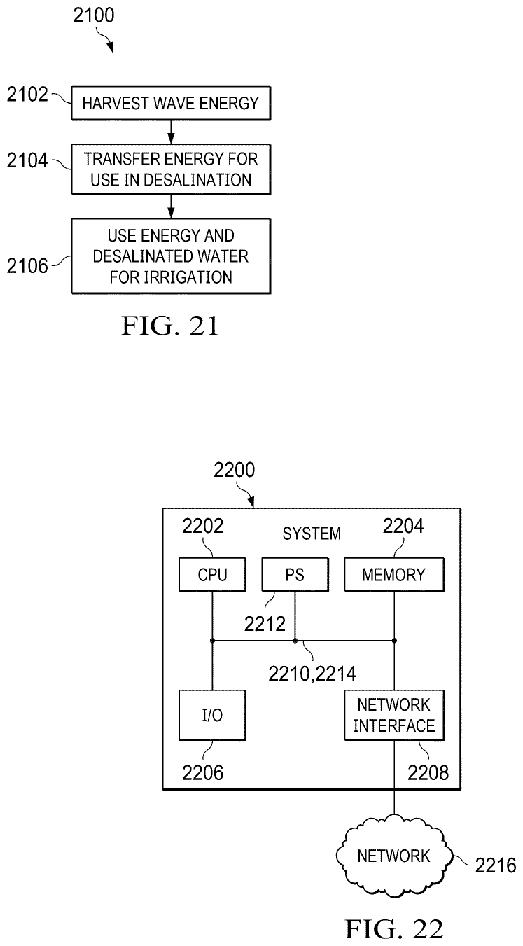

Referring to FIG. 21, one embodiment of a flow chart 2100 illustrates a process that may be executed with the environment 100 of FIGS. 1A-1C. In step 2102, wave energy is harvested by the energy harvesting system 102. In step 2104, the harvested energy is transferred for use in desalination, such as to the energy storage/use system 104. In step 2106, the energy may be used for irrigation using the desalinated water.

Referring to FIG. 22, one embodiment of a computer system 2200 is illustrated. The computer system 2200 is one possible example of a system component or computing device that may be used as part of the energy harvesting system 102 (FIGS. 1A-1C), the energy storage/use system 104 (FIGS. 1A-1C), and/or the control system 2000 (FIG. 20). The computer system 2200 may include a controller (e.g., a central processing unit (“CPU”)) 2202, a memory unit 2204, an input/output (“I/O”) device 2206, and a network interface 2208. The components 2202, 2204, 2206, and 2208 are interconnected by a transport system (e.g., a bus) 2210. A power supply (PS) 2212 may provide power to components of the computer system 2200, such as the CPU 2202 and memory unit 2204, via a power line 2214 that may be combined with, or be separate from, the transport system 2210.

It is understood that the computer system 2200 may be differently configured and that each of the listed components may actually represent several different components. For example, the CPU 2202 may actually represent a multi-processor or a distributed processing system; the memory unit 2204 may include different levels of cache memory, main memory, hard disks, and remote storage locations; the I/O device 2206 may include monitors, keyboards, and the like; and the network interface 2208 may include one or more network cards providing one or more wired and/or wireless connections to a network 2216. Therefore, a wide range of flexibility is anticipated in the configuration of the computer system 2200.

The computer system 2200 may use any operating system (or multiple operating systems), including various versions of operating systems provided by Microsoft (such as WINDOWS), Apple (such as Mac OS X), UNIX, and LINUX, and may include operating systems specifically developed for handheld devices, personal computers, and servers depending on the use of the computer system 1400. The operating system, as well as other instructions (e.g., for the processes and message sequences described herein), may be stored in the memory unit 2204 and executed by the processor 2202. For example, if the computer system 2200 is the control system 2000, the memory unit 2204 may include instructions for performing some or all of the methods described in the present disclosure.

The network 2216 may be a single network or may represent multiple networks, including networks of different types. For example, components within the active geothermal system 102 may be coupled to a network that includes a cellular link coupled to a data packet network, or data packet link such as a wide local area network (WLAN) coupled to a data packet network. Accordingly, many different network types and configurations may be used to establish communications between components within the active geothermal system 102 and with other device and systems.

Exemplary network, system, and connection types include the internet, WiMax, local area networks (LANs) (e.g., IEEE 802.11a and 802.11g wi-fi networks), digital audio broadcasting systems (e.g., HD Radio, T-DMB and ISDB-TSB), terrestrial digital television systems (e.g., DVB-T, DVB-H, T-DMB and ISDB-T), WiMax wireless metropolitan area networks (MANs) (e.g., IEEE 802.16 networks), Mobile Broadband Wireless Access (MBWA) networks (e.g., IEEE 802.20 networks), Ultra Mobile Broadband (UMB) systems, Flash-OFDM cellular systems, and Ultra wideband (UWB) systems. Furthermore, the present disclosure may be used with communications systems such as Global System for Mobile communications (GSM) and/or code division multiple access (CDMA) communications systems. Connections to such networks may be wireless or may use a conduit (e.g., digital subscriber conduits (DSL), cable conduits, and fiber optic conduits).

Communication may be accomplished using predefined and publicly available (i.e., non-proprietary) communication standards or protocols (e.g., those defined by the Internet Engineering Task Force (IETF) or the International Telecommunications Union-Telecommunications Standard Sector (ITU-T)), and/or proprietary protocols. For example, signaling communications (e.g., session setup, management, and teardown) may use a protocol such as the Session Initiation Protocol (SIP), while data traffic may be communicated using a protocol such as the Real-time Transport Protocol (RTP), File Transfer Protocol (FTP), and/or Hyper-Text Transfer Protocol (HTTP). Communications may be connection-based (e.g., using a protocol such as the transmission control protocol/internet protocol (TCP/IP)) or connection-less (e.g., using a protocol such as the user datagram protocol (UDP)). It is understood that various types of communications may occur simultaneously, including, but not limited to, voice calls, instant messages, audio and video, emails, document sharing, and any other type of resource transfer, where a resource represents any digital data.

In one example, a distillation system based on mechanical energy may include an energy harvesting system configured to obtain mechanical energy from water movement; an energy transfer mechanism coupled to the energy harvesting system and configured to transfer the obtained mechanical energy to a distillation apparatus; and the distillation apparatus coupled to the energy transfer mechanism. The distillation apparatus may have a vacuum chamber; an inlet fluid conduit providing access to the vacuum chamber for a fluid; a vacuum mechanism driven only by the mechanical energy provided by the energy transfer mechanism, wherein the vacuum mechanism is configured to create a vacuum in the vacuum chamber in order to lower an amount of energy needed for distillation of the fluid to occur; and an outlet fluid conduit providing access to the fluid after distillation.

In the preceding distillation system, the vacuum mechanism may further include a drive mechanism; a shaft positioned within the vacuum chamber and having an upper end coupled to the drive mechanism; and a bellows coupled to a lower end of the shaft, wherein transferring mechanical energy to the drive mechanism pushes the shaft towards the bottom of the vacuum chamber to create a vacuum.

In any of the preceding distillation systems, the vacuum mechanism may further include a bellows coupled to the upper end of the shaft.

In any of the preceding distillation systems, the drive mechanism may include a substantially cylindrical outer sleeve having a first inner surface and a first outer surface, wherein the first inner surface has a first diameter and a first helical groove disposed therein; a substantially cylindrical ball sleeve having a second inner surface and a second outer surface, wherein the second outer surface has a second diameter less than the first diameter, the ball sleeve having at least one opening from the second outer surface to the second inner surface; a substantially cylindrical inner shaft having a helical groove disposed therein; and a ball bearing positioned within the at least one opening and sized to engage the first and second helical grooves.

In any of the preceding distillation systems, the distillation apparatus may further include a plurality of valves that are configured to open and close based solely on pressure variations within the distillation apparatus and mechanical movement of the vacuum mechanism.

In any of the preceding distillation systems, the vacuum mechanism may further include a shaft positioned within the vacuum chamber; and an arm coupled to the shaft and positioned substantially parallel to the shaft, the arm including first and second arm sections, wherein the first arm section is farther from the shaft than the second arm section, and a sloped transition area joining the first and second arm sections.

In any of the preceding distillation systems, at least one of the plurality of valves may include a valve body having an outer opening and an inner opening, wherein the valve body penetrates a wall of the vacuum chamber near the arm to expose the inner opening to the vacuum chamber; a valve head movable to open and close the inner opening; a valve rod that extends from the valve body through the valve head to the arm; and an end cap positioned to moveably couple the rod to the arm, wherein movement of the arm repositions the end cap and coupled rod relative to the first and second arm sections to open and close the first opening.

In any of the preceding distillation systems, the rod may extend through an elongated opening that runs from the first arm portion, the sloped transition area, and into the second arm portion; and the end cap may be positioned on the opposite side of the elongated opening from the valve body and coupled to the rod.

In any of the preceding distillation systems, the energy harvesting system may include an offshore device positioned in water in a substantially stationary first position relative to a shoreline; an anchor coupled to the offshore device by a line and positioned in a substantially stationary second position relative to a shoreline so the line is substantially perpendicular to a flow of the water, wherein energy from movement of the line is transferred to the offshore device; and a transfer mechanism coupled to the offshore device and extending to the shoreline, wherein the offshore device transfers at least a portion of the energy to the distillation system.

In the preceding distillation system, the offshore device may be a pulley.

In any of the preceding distillation systems, the energy harvesting system may include an offshore device positioned in water in a substantially stationary first position relative to a shoreline; an anchor coupled to the offshore device by a line and positioned in a substantially stationary second position relative to a shoreline so the line is substantially perpendicular to a flow of the water, wherein energy from movement of the line is transferred to the offshore device; and a transfer mechanism coupled to the offshore device and extending to the shoreline, wherein the offshore device transfers at least a portion of the energy to the distillation system, wherein the transfer mechanism may be part of the line.

In any of the preceding distillation systems, the offshore device may include a pivot point located at the first position; a first arm coupled to the pivot point, wherein an outer end of the first arm is coupled to the line; and a second arm coupled to the transfer mechanism, wherein an outer end of the second arm is coupled to the transfer mechanism.

In the preceding distillation system, the second arm may be longer than the first arm.

In any of the preceding distillation systems, the energy harvesting system may include an offshore device positioned in water in a substantially stationary first position relative to a shoreline; an anchor coupled to the offshore device by a line and positioned in a substantially stationary second position relative to a shoreline so the line is substantially perpendicular to a flow of the water, wherein energy from movement of the line is transferred to the offshore device; and a transfer mechanism coupled to the offshore device and extending to the shoreline, wherein the offshore device transfers at least a portion of the energy to the distillation system, and wherein the offshore device includes a vertically oriented pin located at the first position; a first pulley centered on the pin and coupled to the line; and a second pulley centered on the pin and coupled to the transfer mechanism.

In the preceding distillation system, the second pulley may be larger in diameter than the first pulley.

In any of the preceding distillation systems, the energy harvesting system may include an offshore device positioned in water in a substantially stationary first position relative to a shoreline, wherein energy from movement of the line is transferred to the offshore device; an anchor coupled to the offshore device by a first line and positioned in a substantially stationary second position; and a second line coupled to the offshore device and extending to the shoreline, wherein the second line includes a tension assembly.

In the preceding distillation system, the tension assembly may include a spring held in place by retaining components coupled to the second line.

In any of the preceding distillation systems, the energy harvesting system may include an offshore device positioned in water in a substantially stationary position relative to a shoreline, the offshore device including a body having a frame with first and second ends coupled by first and second connectors, wherein the frame is to be positioned with the first and second connectors substantially parallel to a flow of the water; at least first and second pulleys coupled to the first and second connectors between the first and second ends; a belt positioned around the first and second pulleys to create a substantially flat first surface above the pulleys and create a substantially flat second surface below the first surface; a plurality of paddles coupled to the belt and configured to rotate the belt when the flow of water engages at least a portion of the paddles; and an energy transfer mechanism coupled to at least one of the pulleys to obtain mechanical energy from the rotating belt.

In the preceding distillation system, the plurality of paddles may be non-flexible and coupled to the belt with a hinge, and the belt may include an indentation for each of the paddles.

In the preceding distillation system, the indentation for each of the paddles may include a protrusion above the hinge, wherein the protrusion is sized to enable the paddle to raise only to a certain point.

In any of the preceding distillation systems, the energy harvesting system may include an offshore device positioned in water in a substantially stationary position relative to a shoreline, the offshore device including a body having a frame with first and second ends coupled by first and second connectors, wherein the frame is to be positioned with the first and second connectors substantially parallel to a flow of the water; at least first and second pulleys coupled to the first and second connectors between the first and second ends; a belt positioned around the first and second pulleys to create a substantially flat first surface above the pulleys and create a substantially flat second surface below the first surface; a plurality of paddles coupled to the belt and configured to rotate the belt when the flow of water engages at least a portion of the paddles; and an energy transfer mechanism coupled to at least one of the pulleys to obtain mechanical energy from the rotating belt, wherein the plurality of paddles are flexible and coupled to the belt with a hinge, and wherein the offshore device further includes a plurality of flexible straps coupled to the paddles and the belt, the flexible straps having a length to limit movement of the coupled paddles to a range from flat against the belt to substantially perpendicular to the belt when the flow of water engages the paddles.

In the preceding distillation system, the plurality of paddles may be formed using a plurality of linked strips.

In any of the preceding distillation systems, the energy harvesting system may include a pivot bar positioned substantially perpendicular to a flow of water; a lever arm coupled to the pivot arm at a pivot point, the lever arm positioned in a neutral position substantially parallel to the flow of water, wherein the pivot point enables the lever arm to sweep through a range of motion on either side of the neutral position; and an energy harvesting bar positioned downstream from the pivot bar, the energy harvesting bar having at least one component configured to receive energy from the motion of the lever arm.

In the preceding distillation system, the distillation system may further include a rudder coupled to the lever arm, wherein movement of the rudder controls the orientation of the lever arm relative to the neutral position.

In the preceding distillation system, the distillation system may further include a water wheel coupled to the rudder, the water wheel including a grooved track that engages the rudder and causes the rudder to alter the orientation of the lever arm.

In any of the preceding distillation systems, the energy harvesting system may include a pivot bar positioned substantially perpendicular to a flow of water; a lever arm coupled to the pivot arm at a pivot point, the lever arm positioned in a neutral position substantially parallel to the flow of water, wherein the pivot point enables the lever arm to sweep through a range of motion on either side of the neutral position; and an energy harvesting bar positioned downstream from the pivot bar, the energy harvesting bar having at least one component configured to receive energy from the motion of the lever arm, wherein the at least one component is a piston assembly coupled to the lever arm.

In the preceding distillation system, the distillation system may further include a piston chamber positioned at the energy harvesting bar and configured to contain at least a portion of the piston assembly.

In any of the preceding distillation systems, the energy transfer mechanism may transfer the energy using one or more electrical lines.

In any of the preceding distillation systems, the energy transfer mechanism may transfer the energy using one or more fluid lines.

In any of the preceding distillation systems, the energy transfer mechanism may transfer the energy using one or more mechanical mechanisms.

In any of the preceding distillation systems, the energy transfer mechanism may transfer the energy using one or more mechanical mechanisms that is a line.

In any of the preceding distillation systems, the energy transfer mechanism may transfer the energy using one or more mechanical mechanisms that is a drivetrain.

In another example, a distillation apparatus may include a vacuum chamber; an inlet fluid conduit providing access to the vacuum chamber for a fluid; a vacuum mechanism driven only by mechanical energy provided by an energy transfer mechanism, wherein the vacuum mechanism is configured to create a vacuum in the vacuum chamber in order to lower an amount of energy needed for distillation of the fluid to occur; and an outlet fluid conduit providing access to the fluid after distillation.

In the preceding distillation apparatus, the vacuum mechanism may further include a drive mechanism; a shaft positioned within the vacuum chamber and having an upper end coupled to the drive mechanism; and a bellows coupled to a lower end of the shaft, wherein transferring mechanical energy to the drive mechanism pushes the shaft towards the bottom of the vacuum chamber to create a vacuum.

In the preceding distillation apparatus, the vacuum mechanism may further include a bellows coupled to the upper end of the shaft.

In any of the preceding distillation apparatuses, the vacuum mechanism may further include a drive mechanism; a shaft positioned within the vacuum chamber and having an upper end coupled to the drive mechanism; and a bellows coupled to a lower end of the shaft, wherein transferring mechanical energy to the drive mechanism pushes the shaft towards the bottom of the vacuum chamber to create a vacuum, wherein the drive mechanism includes a substantially cylindrical outer sleeve having a first inner surface and a first outer surface, wherein the first inner surface has a first diameter and a first helical groove disposed therein; a substantially cylindrical ball sleeve having a second inner surface and a second outer surface, wherein the second outer surface has a second diameter less than the first diameter, the ball sleeve having at least one opening from the second outer surface to the second inner surface; a substantially cylindrical inner shaft having a helical groove disposed therein; and a ball bearing positioned within the at least one opening and sized to engage the first and second helical grooves.

In any of the preceding distillation apparatuses, the vacuum mechanism may be configured to advance a vacuum state each time it receives an incremental amount of energy from the energy transfer system.

In the preceding distillation apparatus, the incremental amount of energy may be received as a mechanical stroke.

In another example, an apparatus for harvesting energy from moving water may include at least one U-shaped tube having a first end and a second end, wherein the first and second ends are both positioned below a surface of a body of water, and a connecting portion positioned between the first and second ends and above the surface, wherein the connecting portion is narrow relative to the remainder of the tube and has at least one impellor positioned therein, the impellor being coupled to a shaft, wherein air within the tube is pushed across the impellor to turn the shaft as a level of water within the first and second ends of the tube rises and falls.

In another example, an apparatus for harvesting energy from moving water may include a belt coupling first and second rotating members, wherein the belt is positioned in a body of water and is substantially perpendicular to movement of the water; a plurality of paddles coupled to the belt, wherein the paddles are configured to engage moving water and rotate the belt in a first direction; and an energy transfer mechanism configured to obtain energy from at least one of the rotating belt, the first rotating member, and the second rotating member.

In another example, a system for harvesting energy from moving water may include a pulley having a relatively stationary position below the surface of a body of water; a float positioned above the pulley; and a line coupled to the float and an object on a shore of the body of water, the line engaging the pulley between the anchor and the object, wherein movement of the float by the water results in a pumping action at the object via the line.

In another example, a system for harvesting energy from moving water may include an anchor having a relatively stationary position relative to a bed of a body of water; a pulley having a relatively stationary position relative to the bed; and a line coupled to the anchor and an object on a shore of the body of water, the line engaging the pulley between the anchor and the object with the line positioned between the anchor and the pulley substantially perpendicular to the water's movement, wherein movement of the line by the water results in a pumping action at the object.

In another example, a method for providing desalinated water for irrigation may include harvesting mechanical energy from water movement in a body of salt water; transferring the mechanical energy for use on land; using a portion of the mechanical energy to desalinate salt water to obtain fresh water, wherein desalinating the salt water may include providing the salt water to a distillation apparatus; creating a vacuum in a vacuum chamber of the distillation apparatus using a portion of the mechanical energy, wherein only mechanical energy is used to create the vacuum; providing heat to the distillation apparatus; collecting fresh water from the vacuum chamber; and using a portion of the mechanical energy to drive an irrigation process using the fresh water.

In another example, a method for distilling fluid may include harvesting mechanical energy from water movement; transferring the mechanical energy for use by a distillation apparatus; using the mechanical energy to distill a fluid, wherein distilling the fluid may include providing the fluid to the distillation apparatus; creating a vacuum in a vacuum chamber of the distillation apparatus using only the mechanical energy; providing heat to the distillation apparatus; and collecting the distilled fluid.

In the preceding method, providing the heat may include exposing at least a portion of the distillation apparatus to solar energy.

In any of the preceding methods, providing the heat may include exposing at least a portion of the distillation apparatus to solar energy.

In any of the preceding methods, creating the vacuum may include advancing a vacuum state each time the distillation apparatus receives an incremental amount of energy from the energy transfer system.

In the preceding method, the incremental amount of energy may be received as a mechanical stroke.

In any of the preceding methods, some or all of the energy may be allocated to different parts of any of the systems at different times.

In any of the preceding systems and methods, the harvested power and/or water may be used for irrigation.

In any of the preceding systems and methods, the harvested power and/or water may be used for livestock watering.

In any of the preceding systems and methods, the harvested power and/or water may be used for industry.

In any of the preceding systems and methods, the harvested power and/or water may be used for human consumption.

While the preceding description shows and describes one or more embodiments, it will be understood by those skilled in the art that various changes in form and detail may be made therein without departing from the spirit and scope of the present disclosure. For example, various steps illustrated within a particular sequence diagram or flow chart may be combined or further divided. In addition, steps described in one diagram or flow chart may be incorporated into another diagram or flow chart. Furthermore, the described functionality may be provided by hardware and/or software, and may be distributed or combined into a single platform. Additionally, functionality described in a particular example may be achieved in a manner different than that illustrated, but is still encompassed within the present disclosure. Therefore, the claims should be interpreted in a broad manner, consistent with the present disclosure.

What is claimed is:

1. A distillation system based on mechanical energy comprising:
an energy harvesting system configured to obtain mechanical energy from water movement;
an energy transfer mechanism coupled to the energy harvesting system and configured to transfer the obtained mechanical energy to a distillation apparatus coupled to the energy transfer mechanism; and
the distillation apparatus, the distillation apparatus having:
a vacuum chamber;
an inlet fluid conduit providing access to the vacuum chamber for a fluid;
a vacuum mechanism driven only by the mechanical energy provided by the energy transfer mechanism, wherein the vacuum mechanism is configured to create a vacuum in the vacuum chamber in order to lower an amount of energy needed for distillation of the fluid to occur; and
an outlet fluid conduit providing access to the fluid after distillation.

2. The distillation system of claim 1 wherein the vacuum mechanism further includes:
a drive mechanism;
a shaft positioned within the vacuum chamber and having an upper end coupled to the drive mechanism; and
a bellows coupled to a lower end of the shaft, wherein transferring mechanical energy to the drive mechanism pushes the shaft towards the bottom of the vacuum chamber to create a vacuum.

3. The distillation system of claim 2 wherein the vacuum mechanism further includes a bellows coupled to the upper end of the shaft.

4. The distillation system of claim 2 wherein the drive mechanism includes:
a substantially cylindrical outer sleeve having a first inner surface and a first outer surface, wherein the first inner surface has a first diameter and a first helical groove disposed therein;
a substantially cylindrical ball sleeve having a second inner surface and a second outer surface, wherein the second outer surface has a second diameter less than the first diameter, the ball sleeve having at least one opening from the second outer surface to the second inner surface;
a substantially cylindrical inner shaft having a helical groove disposed therein; and
a ball bearing positioned within the at least one opening and sized to engage the first and second helical grooves.

5. The distillation system of claim 1 wherein the distillation apparatus further includes a plurality of valves that are configured to open and close based solely on pressure variations within the distillation apparatus and mechanical movement of the vacuum mechanism.

6. The distillation system of claim 5 wherein the vacuum mechanism further includes:
a shaft positioned within the vacuum chamber; and
an arm coupled to the shaft and positioned substantially parallel to the shaft, the arm including
first and second arm sections, wherein the first arm section is farther from the shaft than the second arm section, and
a sloped transition area joining the first and second arm sections.

7. The distillation system of claim 6 wherein at least one of the plurality of valves includes:
a valve body having an outer opening and an inner opening, wherein the valve body penetrates a wall of the vacuum chamber near the arm to expose the inner opening to the vacuum chamber;
a valve head movable to open and close the inner opening;
a valve rod that extends from the valve body through the valve head to the arm; and
an end cap positioned to moveably couple the rod to the arm, wherein movement of the arm repositions the end cap and coupled rod relative to the first and second arm sections to open and close the first opening.

8. The distillation system of claim 7 wherein the rod extends through an elongated opening that runs from the first arm portion, the sloped transition area, and into the second arm portion; and the end cap is positioned on the opposite side of the elongated opening from the valve body and coupled to the rod.

9. The distillation system of claim 1 wherein the energy harvesting system includes:
an offshore device positioned in water in a substantially stationary first position relative to a shoreline;
an anchor coupled to the offshore device by a line and positioned in a substantially stationary second position relative to a shoreline so the line is substantially perpendicular to a flow of the water, wherein energy from movement of the line is transferred to the offshore device; and
a transfer mechanism coupled to the offshore device and extending to the shoreline, wherein the offshore device transfers at least a portion of the energy to the distillation system.

10. The distillation system of claim 9 wherein the offshore device is a pulley.

11. The distillation system of claim 9 wherein the offshore device includes:
a pivot point located at the first position;
a first arm coupled to the pivot point, wherein an outer end of the first arm is coupled to the line; and
a second arm coupled to the transfer mechanism, wherein an outer end of the second arm is coupled to the transfer mechanism.

12. The distillation system of claim 1 wherein the energy harvesting system includes an offshore device positioned in water in a substantially stationary position relative to a shoreline, the offshore device including:
a body having a frame with first and second ends coupled by first and second connectors, wherein the frame is to be positioned with the first and second connectors substantially parallel to a flow of the water;
at least first and second pulleys coupled to the first and second connectors between the first and second ends;
a belt positioned around the first and second pulleys to create a substantially flat first surface above the pulleys and create a substantially flat second surface below the first surface;
a plurality of paddles coupled to the belt and configured to rotate the belt when the flow of water engages at least a portion of the paddles; and
an energy transfer mechanism coupled to at least one of the pulleys to obtain mechanical energy from the rotating belt.

13. The distillation system of claim 12 wherein the plurality of paddles are non-flexible and coupled to the belt with a hinge, and wherein the belt includes an indentation for each of the paddles.

14. The distillation system of claim 13 wherein the indentation for each of the paddles includes a protrusion above the hinge, wherein the protrusion is sized to enable the paddle to raise only to a certain point.

15. The distillation system of claim 13 wherein the plurality of paddles are flexible and coupled to the belt with a hinge, and wherein the offshore device further includes a plurality of flexible straps coupled to the paddles and the belt, the flexible straps having a length to limit movement of the coupled paddles to a range from flat against the belt to substantially perpendicular to the belt when the flow of water engages the paddles.

16. A method for providing desalinated water for irrigation, the method comprising:
harvesting mechanical energy from water movement;
transferring the mechanical energy for use by a distillation apparatus; and
using the mechanical energy to distill a fluid, wherein distilling the fluid includes:
providing the fluid to the distillation apparatus;
creating a vacuum in a vacuum chamber of the distillation apparatus using only the mechanical energy;
providing heat to the distillation apparatus; and
collecting the distilled fluid.

17. The method of claim 16 wherein providing the heat includes exposing at least a portion of the distillation apparatus to solar energy.

18. The method of claim 16 wherein creating the vacuum includes advancing a vacuum state each time the distillation apparatus receives an incremental amount of mechanical energy from the energy transfer system.

19. The method of claim 18 further including receiving the incremental amount of energy as a mechanical stroke.

20. The method of claim 16 further including opening and closing a plurality of valves of the distillation apparatus based solely on pressure variations within the distillation apparatus and mechanical movement of the distillation apparatus.
